(19) United States
(12) Patent Application Publication
(10) Pub. No.: US 2012/0304054 A1
(43) Pub. Date: Nov. 29, 2012

(54) SYSTEMS AND METHODS FOR CLINICAL ASSESSMENT AND NOTING TO SUPPORT CLINICIAN WORKFLOWS

(75) Inventors: Jennifer Orf, Seattle, WA (US); Patricia Marshall, Seattle, WA (US); Joel Ronald Gray, Tucson, AZ (US); Jon Griep, Seattle, WA (US); Alejandro Santiago, Seattle, WA (US); Jonathan Fernald, South Burlington, VT (US); Cheryl Morrison, Seattle, WA (US); Zorawar Kooner, Seattle, WA (US); Karman Cheung, Seattle, WA (US); Radhakrishnan Ramaiah, Seattle, WA (US)

(73) Assignee: General Electric Company, Schenectady, NY (US)

(21) Appl. No.: 13/482,484

(22) Filed: May 29, 2012

Related U.S. Application Data
(60) Provisional application No. 61/491,055, filed on May 27, 2011.

(51) Int. Cl. G06F 17/00

(52) U.S. Cl. 715/255

(57) ABSTRACT

Certain examples provide systems, apparatus and methods for electronic clinical documentation of patient information. An example method includes facilitating review and edit of a selected clinician document via a graphical user interface. The example method includes automatically reviewing, using a processor, and providing an indication of required information that has not been completed in the selected document. The example method includes facilitating user completion of uncompleted required information via the user interface. The example method includes saving the selected clinician document for later review, the selected clinician document associated with a completion status. The example method includes finalizing the selected clinician document for output upon user approval via the user interface.

### CROSS-REFERENCE TO RELATED APPLICATIONS

This patent claims priority to U.S. Provisional Application Ser. No. 61/491,055, entitled “SYSTEMS AND METHODS FOR CLINICAL ASSESSMENT AND NOTING TO SUPPORT CLINICIAN WORKFLOWS,” which was filed on May 27, 2011 and is hereby incorporated herein by reference in its entirety.

### FIELD

The presently disclosed technology generally relates to electronic clinical documentation of patient information and, more specifically, relates to electronic, dynamic generation of clinical notes and instructions.

### BACKGROUND

Information helps provide a more comprehensive patient record and facilitate improved patient diagnosis and treatment. Electronic systems provide electronic medical records, but clinicians are often left without appropriate tools for information capture and documentation.

### SUMMARY

Certain examples provide systems, apparatus and methods for electronic clinical documentation of patient information. Certain examples provide systems, apparatus and methods for electronic, dynamic generation, saving, review and finalization of clinical notes and instructions.

Certain examples provide a method including facilitating review and edit of a selected clinician document via a graphical user interface. The example method includes automatically reviewing, using a processor, and providing an indication of required information that has not been completed in the selected document. The example method includes facilitating user completion of uncompleted required information via the user interface. The example method includes saving the selected clinician document for later review, the selected clinician document associated with a completion status. The example method includes finalizing the selected clinician document for output upon user approval via the user interface.

Certain examples provide a tangible computer-readable storage medium including instructions for execution by a processor, the instructions when executed implementing a method to facilitate clinician documentation. The example method includes facilitating review and edit of a selected clinician document via a graphical user interface. The example method includes automatically reviewing and providing an indication of required information that has not been completed in the selected document. The example method includes facilitating user completion of uncompleted required information via the user interface. The example method includes saving the selected clinician document for later review, the selected clinician document associated with a completion status. The example method includes finalizing the selected clinician document for output upon user approval via the user interface.

Certain examples provide a system including a processor and a memory, the memory storing instructions to enable the processor to implement a user interface. The example user interface is arranged to facilitate review and edit of a selected clinician document via a graphical user interface. The example interface is arranged to automatically review, using the processor, and provide an indication of required information that has not been completed in the selected document. The example interface is arranged to facilitate user completion of uncompleted required information via the user interface. The example interface is arranged to save the selected clinician document for later review, the selected clinician document associated with a completion status. The example interface is arranged to finalize the selected clinician document for output upon user approval via the user interface.

### BRIEF DESCRIPTION OF THE DRAWINGS

FIG. 1 is a block diagram of an example healthcare environment in which the example methods, apparatus, systems, and/or articles of manufacture disclosed herein can be implemented.

FIG. 2 illustrates a flow diagram of an example workflow for nurse or other clinician creation, review, and update of patient assessments.

FIG. 3 illustrates a flow diagram of an example workflow involving beginning to work on a note.

FIG. 4 illustrates an example flowform workflow.

FIG. 5 illustrates a flow diagram of an example method to display data in a note.

FIG. 6 illustrates an example advanced note status workflow.

FIG. 7 shows an example status displayed for each flowform page.

FIG. 8 provides an example guide to status indicators on flowform pages.

FIG. 9 provides an example guide to statuses of flowform assessment services based on a flowform state and associated status update.

FIG. 10 illustrates an example flowform assessment status and other section statuses displayed in a section navigator available via a clinical note builder.

FIG. 11 provides an example guide to section navigator status indicators.

FIG. 12 provides an example guide to note service status.

FIG. 13 illustrates an example of a clinical note builder.

FIG. 14 illustrates an example of an additional note being added to a clinical note via a note builder.

FIG. 15 illustrates an example note builder interface including an alert indicating that one or more sections are required but not yet completed.

FIG. 16 illustrates a flow diagram of an example method for completion of tasks to discharge a patient from a facility.

FIG. 17 illustrates a flow diagram of an example method to determine a patient's discharge needs.

FIG. 18 illustrates a flow diagram of an example home medication reconciliation workflow.

FIG. 19 illustrates a flow diagram of an example method to process a prescription for an ambulatory patient.

FIG. 20 illustrates an example patient discharge instruction creation workflow.

FIG. 21 illustrates an example patient discharge instruction finalization workflow.

FIG. 22 depicts an example patient discharge instruction maintenance workflow.

FIG. 23 illustrates a flow diagram of an example method for a content database load.

FIGS. 24-26 illustrate examples of patient discharge instruction creation interfaces.

FIG. 27 illustrates an example interface to allow users to preview, print and finalize a patient discharge instructions document.

FIG. 28 shows an example interface to facilitate user access to a patient discharge instruction document set once the document set is finalized.

FIG. 29 provides a flow diagram for an example method for adding patients to a registry.

FIG. 30 provides a flow diagram of an example method to notify of a change in patient status.

FIG. 31 is a block diagram of an example processor system that may be used to implement the systems, apparatus and methods described herein.

The following detailed description of certain implementations of the methods, apparatus, systems, and/or articles of manufacture described herein, will be better understood when read in conjunction with the appended drawings. It should be understood, however, that the methods, apparatus, systems, and/or articles of manufacture described herein are not limited to the arrangements and instrumentality shown in the attached drawings.

### DETAILED DESCRIPTION OF CERTAIN EXAMPLES

Although the following discloses example methods, apparatus, systems, and articles of manufacture including, among other components, firmware and/or software executed on hardware, it should be noted that such methods, apparatus, systems, and/or articles of manufacture are merely illustrative and should not be considered as limiting. For example, it is contemplated that any or all of these firmware, hardware, and/or software components could be embodied exclusively in hardware, exclusively in software, exclusively in firmware, or in any combination of hardware, software, and/or firmware. Accordingly, while the following describes example methods, apparatus, systems, and/or articles of manufacture, the examples provided are not the only way(s) to implement such methods, apparatus, systems, and/or articles of manufacture.

When any of the appended claims are read to cover a purely software and/or firmware implementation, at least one of the elements in an at least one example is hereby expressly defined to include a tangible medium such as a memory, DVD, CD, Blu-ray, etc. storing the software and/or firmware.

Certain examples provide clinical assessment and noting with embedded statusing and navigation tools that support interrupted clinician workflows. Clinical Assessment and Noting enables nurses to build patient assessment notes for flowcharts, form-based assessments, allergies, and other items. For example, nursing assessments can be created for a current patient. Completed or in-process assessments can be reviewed. “Required” documentation that is not done, partially completed, or completed can be indicated.

Clinicians, such as a nurse, can be interrupted multiple times during a shift and can have to move between multiple patient records. Certain examples provide navigation and reminder tools for the clinician to quickly resume documentation where he or she left off, as well as remind a clinician regarding documentation that has yet to be completed. Certain examples allow hospitals to create workflow and documentation based templates where specific documentation and applications can be grouped and accessed appropriate to the documentation at that point of care for a patient. If a clinician is interrupted, the clinician is able to save documentation that has been completed. A variety of visual indicators (e.g., complete, not started, required, partially completed, etc.) can be provided to remind the clinician of what documentation is not yet done, and navigate to those sections. In certain examples, workflow engines and notification tools, including voice and text reminders and/or summary views of incomplete documentation, allow a clinician to drill back into documentation for completion.

In certain examples, a nursing assessment note can be created by a clinician. Assessment charting data can be added to the note. For example, information about a patient and visit can be added to a clinical note. Sections can be form-based, text-based, selection-based, etc. One or more problems can be associated with the note. One or more allergies, orders, and/or prescriptions can be added to the note. Annotation(s) can be added to the note. Annotation(s) can be added through a document display, clinical note builder, etc.

Additionally, an existing nursing assessment can be reviewed. To complete a visit, a note can be finalized and signed by a clinician or assigned to another provider to sign. A signature can be facilitated by a button selection, a signature selection, an electronic signature, handwritten signature capture, etc.

In certain examples, if a user attempts to finalize a note that has linked assessments, a Finalize Assessments screen can be displayed to list assessments that are candidates for being linked to the note, and a red check mark next to an assessment indicates that it will be linked to and finalized along with the note. A user can clear or select an assessment by clicking on it, and then click or select “Finalize Assessments” to finalize the selected assessments and the note. If an assessment is deselected, associated findings remain linked to the note, but changes to the status of the note are not made to the assessment findings.

Certain examples facilitate better control over data. For example, certain example systems and methods enable care providers to access real-time patient information from existing healthcare information technology (IT) systems together in one location and compare this information against evidence-based best practices.

Certain examples facilitate better control over process. For example, certain example systems and methods provide condition- and role-specific patient views enable a user to prioritize and coordinate care efforts with an institution's agreed upon practice standards and to more effectively apply resources.

Certain examples facilitate better control over outcomes. For example, certain example systems and methods provide patient dashboards that highlight variations from desired practice standards and enable care providers to identify most critical measures within the context of performance-based care.

Certain examples leverage existing IT investments to standardize and centralize data across an organization. In certain examples, this includes accessing multiple systems from a single location, while allowing greater data consistency across the systems and users.

Entities of healthcare enterprises operate according to a plurality of clinical workflows. Clinical workflows are typically defined to include one or more steps or actions to be taken in response to one or more events and/or according to a schedule. Events may include receiving a healthcare message associated with one or more aspects of a clinical record, opening a record(s) for new patient(s), receiving a transferred patient, and/or any other instance and/or situation that requires or dictates responsive action or processing. The actions or steps of a clinical workflow may include placing an order for one or more clinical tests, scheduling a procedure, requesting certain information to supplement a received healthcare record, retrieving additional information associated with a patient, providing instructions to a patient and/or a healthcare practitioner associated with the treatment of the patient, and/or any other action useful in processing healthcare information. The defined clinical workflows can include manual actions or steps to be taken by, for example, an administrator or practitioner, electronic actions or steps to be taken by a system or device, and/or a combination of manual and electronic action(s) or step(s). While one entity of a healthcare enterprise may define a clinical workflow for a certain event in a first manner, a second entity of the healthcare enterprise may define a clinical workflow of that event in a second, different manner. In other words, different healthcare entities may treat or respond to the same event or circumstance in different fashions. Differences in workflow approaches may arise from varying preferences, capabilities, requirements or obligations, standards, protocols, etc. among the different healthcare entities.

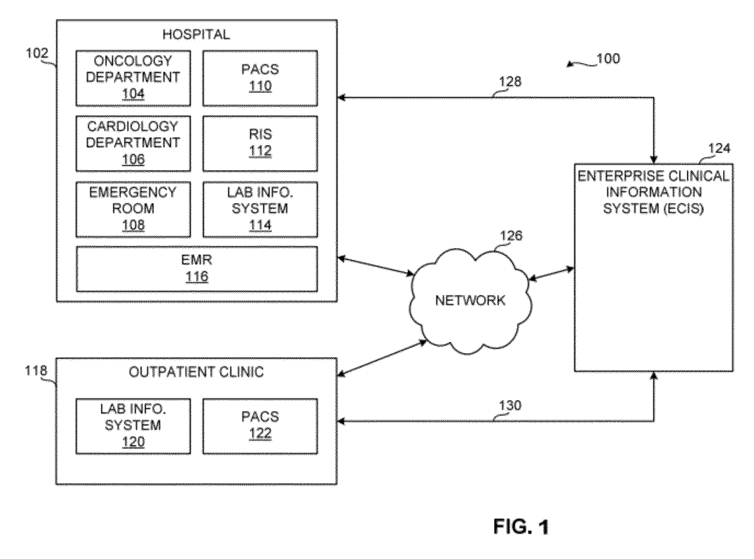

FIG. 1 is a block diagram of an example healthcare environment 100 in which the example methods, apparatus, systems, and/or articles of manufacture disclosed herein for physician notes and other documentation may be implemented. The example healthcare environment 100 of FIG. 1 includes a first hospital 102 having a plurality of entities operating within and/or in association with the first hospital 102. In the illustrated example, the entities of the first hospital 102 include an oncology department 104, a cardiology department 106, an emergency room system 108, a picture archiving and communication system (PACS) 110, a radiology information system (RIS) 112, and a laboratory information system (LIS) 114. The oncology department 104 includes cancer-related healthcare practitioners, staff and the devices or systems that support oncology practices and treatments. Similarly, the cardiology department 106 includes cardiology-related healthcare practitioners, staff and the devices and/or systems that support cardiology practices and treatments. Notably, the example oncology department 104 of FIG. 1 has specifically designed clinical workflows to be executed in response to certain events and/or according to a schedule. At the same time, the example cardiology department 106 of FIG. 1 has specifically designed clinical workflows to be executed in response to certain events and/or according to a schedule that differ from the clinical workflows of the example oncology department 104 of FIG. 1. For example, the oncology department 104 may execute a first set of actions in response to receiving a Healthcare Level 7 (HL7) admission-discharge-transfer (ADT) message, while the cardiology department 106 executes a second set of actions different from the first set of actions in response to receiving a HL7 ADT message. Such differences may also exist between the emergency room 108, the PACS 110, the RIS 112 and/or the accounting services 114.

Briefly, the emergency room system 108 manages information related to the emergency care of patients presenting at an emergency room of the hospital 102, such as admission information, observations from emergency examinations of patients, treatments provided in the emergency room setting, etc. The PACS 110 stores medical images (e.g., x-rays, scans, three-dimensional renderings, etc.) as, for example, digital images in a database or registry. Images are stored in the PACS 110 by healthcare practitioners (e.g., imaging technicians, physicians, radiologists) after a medical imaging of a patient and/or are automatically transmitted from medical imaging devices to the PACS 110 for storage. The RIS 112 stores data related to radiology practices such as, for example, radiology reports, messages, warnings, alerts, patient scheduling information, patient demographic data, patient tracking information, and/or physician and patient status monitors, as well as enables exam order entry (e.g., ordering an x-ray of a patient) and image and film tracking (e.g., tracking identities of one or more people that have checked out a film). The lab information system 114 stores clinical information such as lab results, test scheduling information, corresponding practitioner(s), and/or other information related to the operation(s) of one or more labs at the corresponding healthcare facility. While example types of information are described above as being stored in certain elements of the hospital 102, different types of healthcare data may be stored in one or more of the entities 104-114, as the entities 104-114 and the information listed above is included herein as non-limiting examples. Further, the information stored in entities 104-114 may overlap and/or be combined into one or more of the entities 104-114. Each of the example entities 104-114 of FIG. 1 interacts with an electronic medical record (EMR) system 116. Generally, the EMR 116 stores electronic copies of healthcare records associated with, for example, the hospital 102 and the entities 104-114 thereof.

The example healthcare environment 100 of FIG. 1 also includes an outpatient clinic 118 as an example of another healthcare enterprise. The example outpatient clinic 118 of FIG. 1 includes a lab information system 120 and a PACS 122 that operate similarly to the corresponding entities of the example hospital 102. The lab information system 120 and the PACS 122 of the example outpatient clinic 118 operate according to specifically designed clinical workflows that differ between each other and the clinical workflows of the entities 104-114 of the hospital 102. Thus, differences in clinical workflows can exist between the entities of a healthcare enterprise and between healthcare enterprises in general.

In the illustrated example of FIG. 1, the hospital 102 and the outpatient clinic 118 are in communication with an enterprise clinical information system (ECIS) 124 via a network 126, which may be implemented by, for example, a wireless or wired Wide Area Network (WAN) such as a private network or the Internet, an intranet, a virtual private network, a wired or wireless Local Area Network, etc. More generally, any of the coupling(s) described herein may be via a network. Additionally or alternatively, the example hospital 102 and/or the example outpatient clinic 118 are in communication with the example ECIS 124 via direct or dedicated transmission mediums 128 and 130.

Generally, the ECIS 124 supports healthcare information processing implemented by systems, devices, applications, etc. of healthcare enterprises, such as the hospital 102 and the outpatient clinic 118. The ECIS 124 is capable of processing healthcare messages from different entities of healthcare enterprises (e.g., the entities 104-114 of the hospital 102) that may generate, process and/or transmit the healthcare messages differently and/or using different formats, protocols, policies, terminology, etc. when generating, processing, and/or transmitting the healthcare messages. Moreover, the example ECIS 124 of FIG. 1 supports healthcare practitioners in decision making processes by aggregating healthcare information across disparate enterprises and/or entities thereof and referencing collection(s) of data to automatically generate suggestive and/or definitive data for communication to one or more healthcare practitioners related to the aggregated healthcare information.

Certain examples provide a library of standardized clinical content and proven best practices. Over time, this “library” of content may expand as healthcare organizations add to their own content modules. Because the content is standardized it can be shared and leveraged among organizations using the library and associated clinical knowledge platform. The library and platform help enable organizations to share best practice content. Thus, certain examples provide a clinical knowledge platform that enables healthcare delivery organizations to improve performance against their quality targets.

In certain examples, the ECIS 124 supports and/or includes physician documentation, including online (e.g., Web-based and/or portal accessible) physician documentation and/or physician-focused note writing. Physician in-patent notes can include an admitting note (e.g., admitting history and physical), a progress note, a (preliminary) procedure note (e.g., bedside procedures, operative notes by a surgeon after a procedure, etc), a (preliminary) consult note, a resident/attending note, etc. Emergency Department (ED) physician notes (e.g., multi-author notes), ambulatory notes, discharge notes, handoff notes, (preliminary) nursing assessment notes, physician charge capture notes, and/or specialty notes, etc., can similarly be provided. In certain examples, a notes template is configurable by customer. In certain examples, notes can be integrated with a flowsheet, orders, etc.

In certain examples, patient-clinician assignments and/or relationships can be identified due to clinical events. Records of clinician-patient assignments and/or relationships are maintained to meet regulatory guidelines, requirements, and/or recommendations such as The Joint Commission, Health Insurance Portability and Accountability Act (HIPAA), American Recovery and Reinvestment Act (ARRA) Meaningful Use measures, Certification Commission for Health Information Technology (CCHIT) Certification, etc.

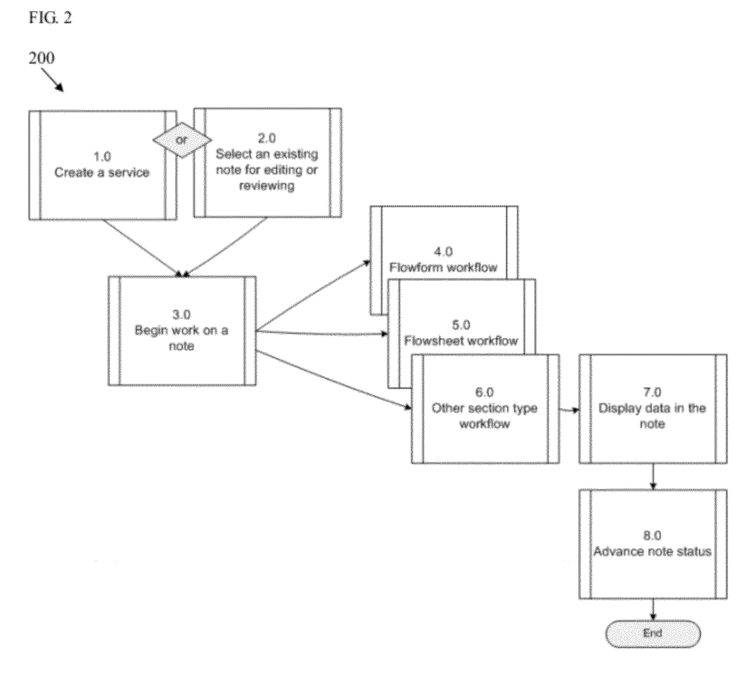

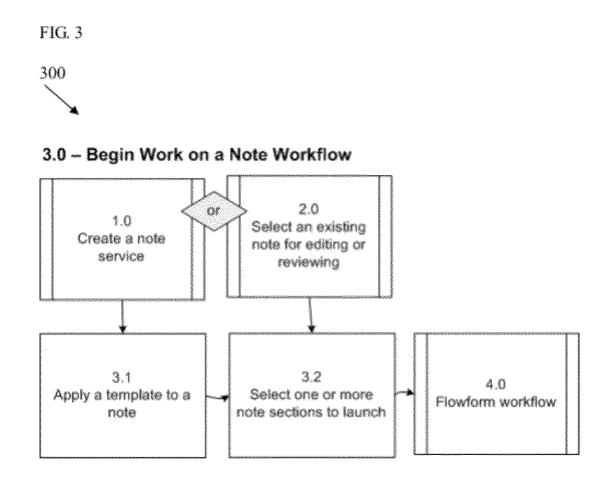

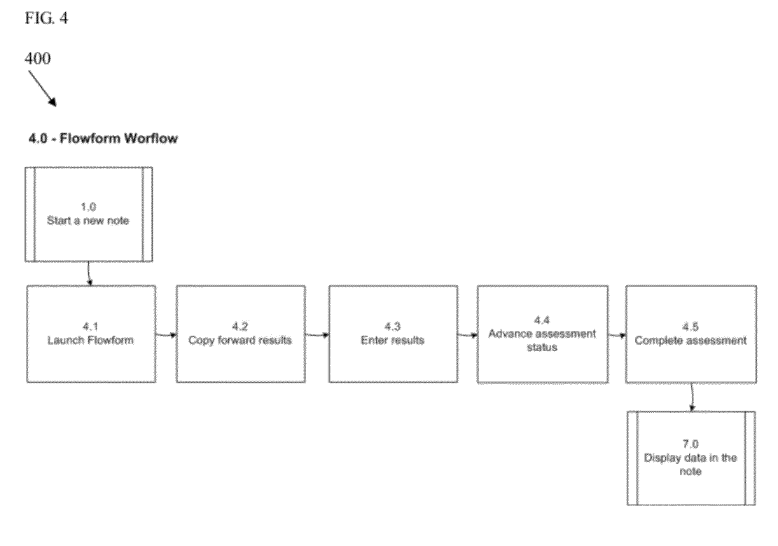

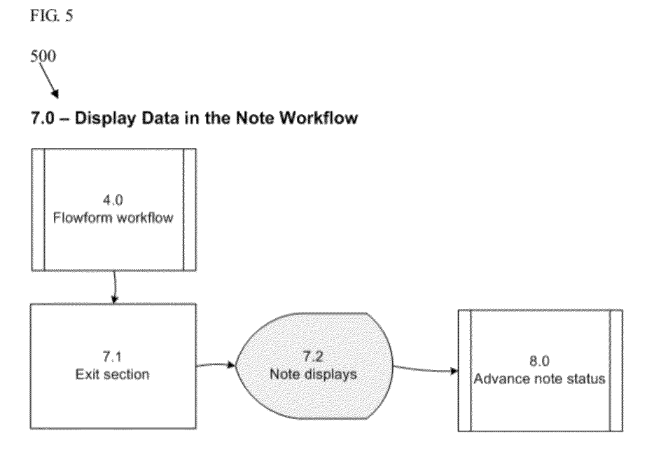

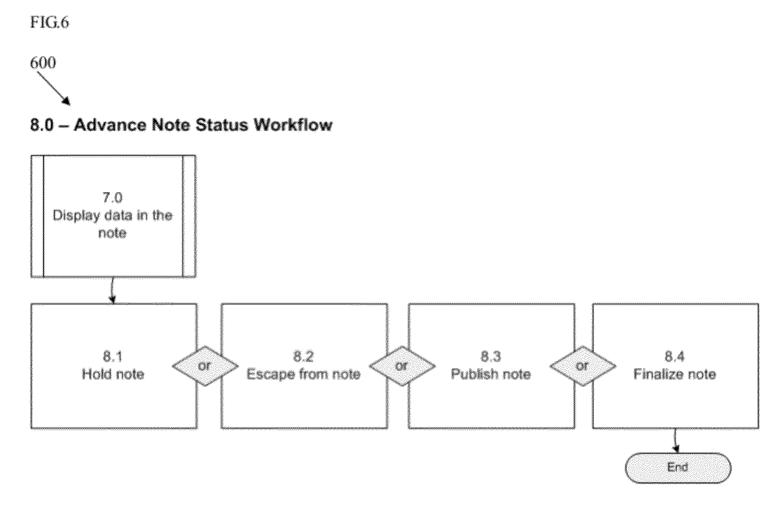

FIG. 2 illustrates a flow diagram for a workflow for nurse or other clinician creation, review, and update of patient assessments. FIG. 3 illustrates a flow diagram for a workflow involving beginning to work on a note. FIG. 4 illustrates an example flowform workflow. FIG. 5 illustrates a flow diagram for a method to display data in a note. FIG. 6 illustrates an example advanced note status workflow.

As illustrated in FIGS. 2-6, at block 1.0, a service is created. A service used for Clinical Assessment and Noting (CAN) is a visit or assessment-type service, for example. A service can be created in another application and used by CAN. A service can also be manually or automatically created in CAN. CAN notes can be attached to a service, for example.

At block 2.0, an existing note is selected for editing or reviewing. A user can put a note on hold and continue work on it later. A user can also put a note into a published status and other authorized users can continue to work on it.

At block 3.0, work begins on a note. A new note or an existing note can be launched to capture a patient's progress. At block 3.1, a template is applied to a note. Information is added to the note by way of a template. Templates can be applied automatically or manually. At block 3.2, one or more sections are selected to launch. Sections that do not yet have required input are displayed with an incomplete icon. Sections that have been worked on but that still have unsatisfied required elements may have a Partial icon. Sections that have been worked on but that do not have unsatisfied required elements are displayed with a complete icon. All the selected sections are launched sequentially, for example.

At block 4.0, in a flowform workflow, templates can include flowforms for gathering assessment information. At block 4.1, a flowform is launched. The titles of pages in a flowform are displayed on each page with the status indicated. At block 4.2, results are copied forward. Flowforms can be set up to copy results from previous assessments to the current assessment. At block 4.3, results are entered. Results from previous assessments that are copied forward to the current assessment can be changed. In addition, new results can be entered. At block 4.4, assessment status can be advanced. The status of the assessment is driven by the statuses of the flowform pages. At block 4.5, an assessment is completed. Information is entered in to the flowform to complete the assessment. Note that flowforms can contain complex calculations, for example.

At block 5.0, in a flowsheet workflow, a flowsheet can be launched to enter information into a grid display. At block 5.1, results are copied forward. Flowsheets can be setup to copy results from previous assessments to the current assessment.

At block 6.0, additional sections can be launched to enter or display orders, problems, prescriptions, free text, allergies, etc.

At block 7.0, information is displayed in the note. Data can be defined to display in the note when the template is applied. At block 7.1, the section is exited. When a section is saved, the status is updated. If the status affects the note status, changes occur when the section is exited. At block 7.2, the note is displayed. The content of the note is defined in the template and by the user during the workflow.

At block 8.0, note status is advanced. Several different actions can be taken to stop the workflow. Some actions can change the status of the note. At block 8.1, a note is held. Holding the note puts it into an incomplete status and only the same user can access the note. At 8.2, a note is escaped. The note remains in the same status it was in before escaping from the note. At 8.3, a note is published. At 8.4, a note is finalized. The note becomes final and cannot be edited without unsigning, for example.

In certain examples, automated statusing is provided for flowforms and notes. Complex calculations are facilitated in flowforms. Copy forward enhancements are also provided.

Findings can be defined as required by flagging the component that connects the finding to its aggregate. When a level two aggregate is involved, resulting one or more findings in the aggregate can satisfy the requirement. For example, a new process flag, e.g., “!”, can be provided in a flowform component. In certain examples, a requirement is a “soft requirement”, where the page can be saved and dismissed without resulting in a required finding. Whether a required finding is resulted or not, the finding participates in driving page status. Findings can be identified on the screen with tailoring, for example.

In certain examples, a status of required element(s) on a flowform page drive the status of the page. The status of the flowform page(s) drive the status of the assessment service. The status of the assessment service drives the status of the section in the section navigator. The status of the section(s) in the section navigator drive the status of the note service.

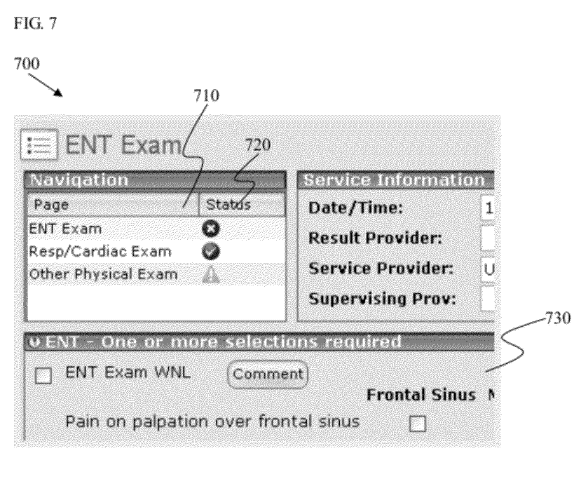

As shown in the example of FIG. 7, a status is displayed for each flowform page. The example ear, nose and throat (ENT) notes 700 include a list of available exam notes 710 and an associated status 720. Each of the available notes 710 is selectable by a user for review, edit, etc. The example interface 730 indicates whether some information is required for a selected exam and is currently missing. The notes interface 700 helps to guide a user to select and complete missing information including a free text comment field if applicable and/or desired.

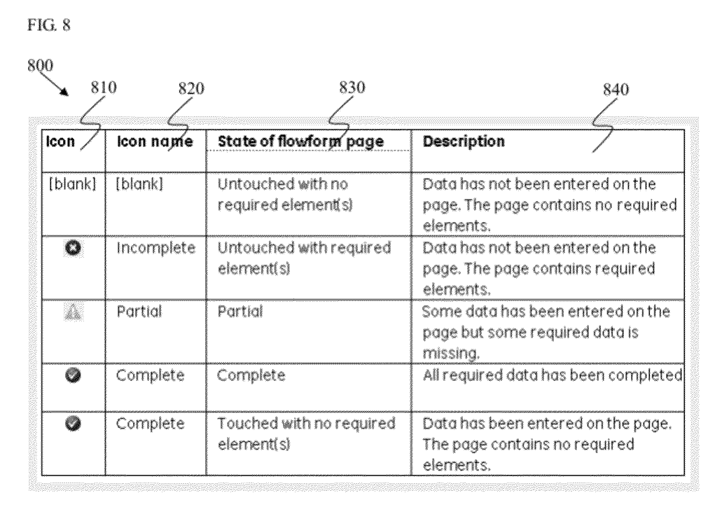

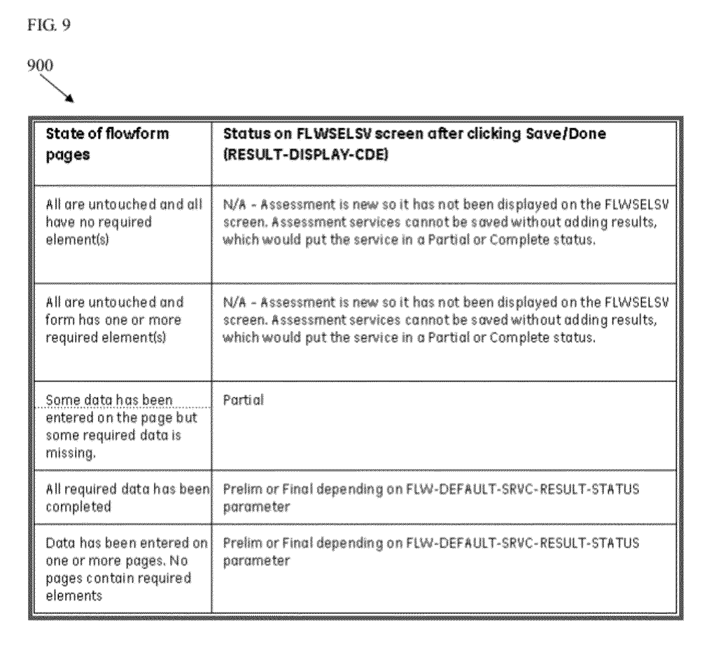

FIG. 8 provides an example guide to status indicators on flowform pages. In certain examples, collective flowform page status drives assessment service status. Assessment service can be saved by a user. As shown in FIG. 8, a plurality of available icons 810 are provided. Each icon 810 has a name 820 (e.g., blank, incomplete, partial, complete, etc.). Each icon 810 is associated with a form state 830. The state 830 includes untouched with no required element(s), untouched with required element(s), partial, complete, touched with no required element(s), etc. Each icon 810 is also associated with a description 840 explaining the application/form state 830 associated with the icon 810. For example, an untouched with no required element(s) state 830 indicates that data has not been entered in the form, and the form includes no required elements. An untouched with required element(s) state 830 indicates that data has not been entered in the form but the form includes at least some required element(s), for example. A partial state 830 indicates that some data has been entered on a page, but some required data is missing, for example. A complete state 830 indicates that all required data has been completed, for example. A touched with no required element(s) state 830 indicates that data has been entered on a page, but the page includes no required element(s), for example. FIG. 9 provides an example guide 900 to statuses of flowform assessment services based on a flowform state and associated status update.

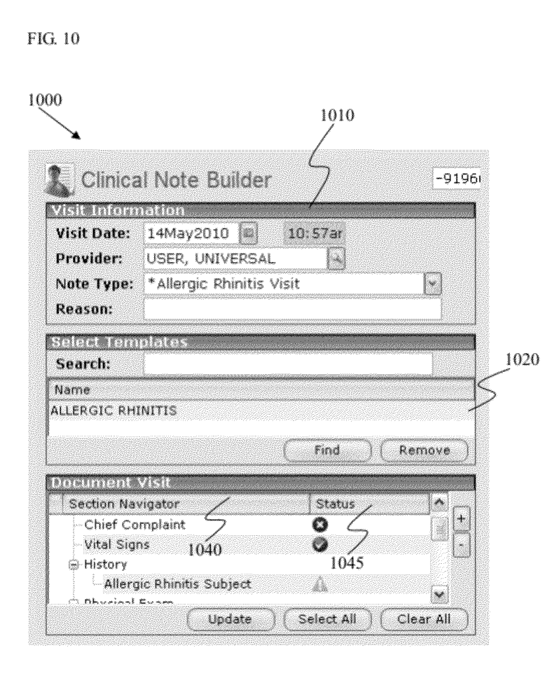

FIG. 10 illustrates an example flowform assessment status and other section statuses displayed in a section navigator available via a clinical note builder 1000. The note builder 1000 includes visit information 1010, template(s) available for selection 1020, and visit documentation 1030 including a section navigator 1040 including one or more notes and a status 1045 associated with each available note 1040.

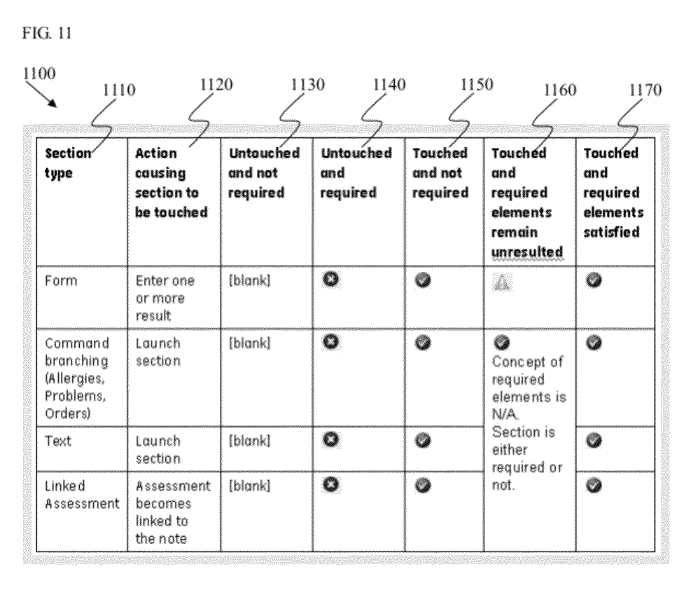

FIG. 11 provides an example guide 1100 to section navigator status indicators. Indicators are organized, for example, by section type 1110, action causing section to be touched 1120, untouched and not required 1130, untouched and required 1140, touched and not required 1150, touched and required elements remain unresulted 1160, touched and required elements satisfied 1170, etc. Thus, for each form section 1110, various section state/status 1120-1170 can be specified to govern form and interface behavior based on user action (e.g., touch).

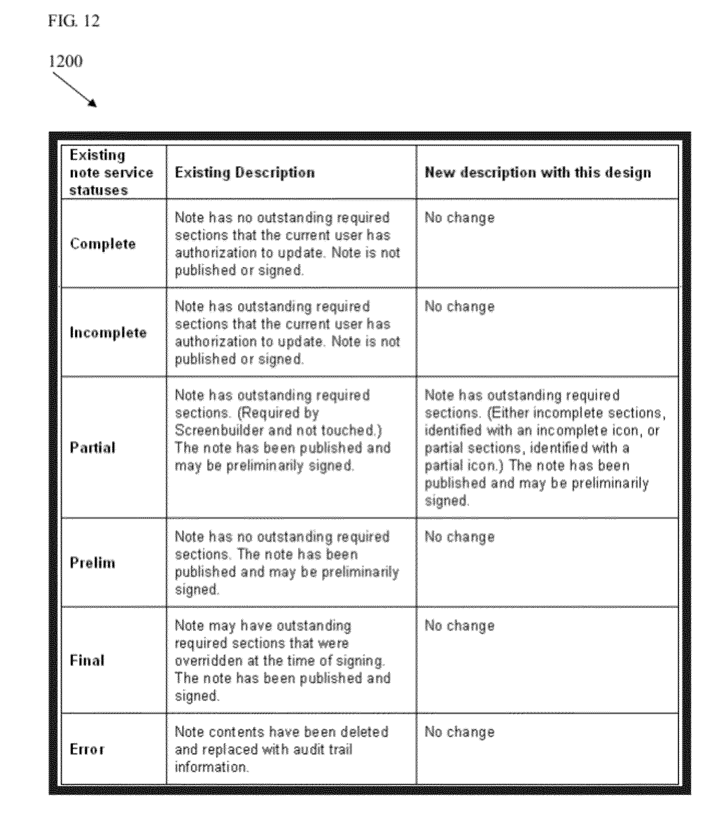

In certain examples, collective section status drives note service status. The note service inherits the status of the template sections. The note status is updated every time the user returns to the note from a section or the note is refreshed. FIG. 12 provides an example guide 1200 to note service status. For example, service status may include complete, incomplete, partial, preliminary, final, error, etc. Each service status is associated with a description explaining the behavior and/or other implication of that status, for example.

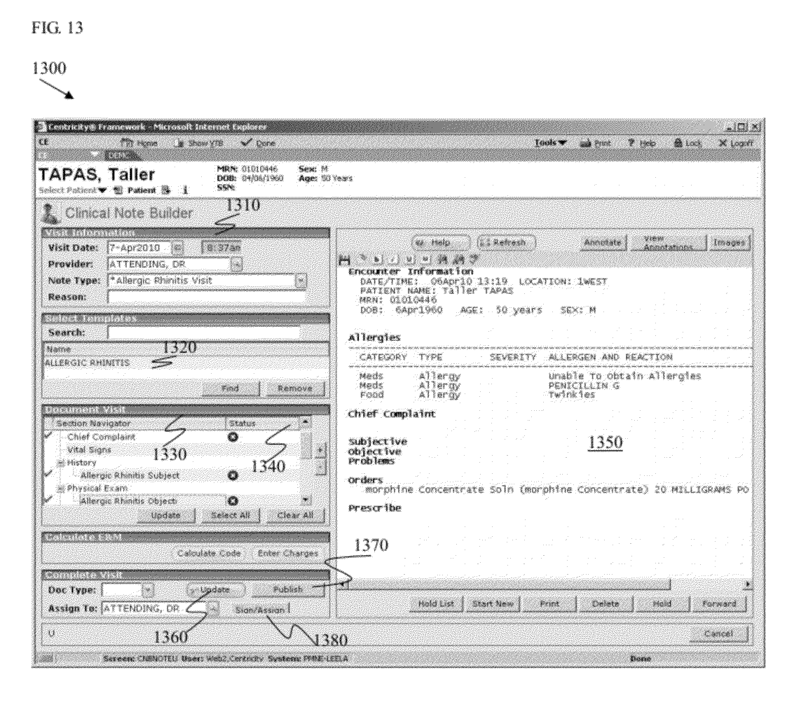

FIG. 13 illustrates an example of a clinical note builder 1300. The note builder 1300 includes one or more fields for a user to provide visit information (e.g., visit date, visit time, provider (e.g., attending physician), note type, reason, etc.) 1310. Additionally, the user can select a template 1320 (e.g., allergic rhinitis, etc.) to generate a note. One or more documents may be associated with the visit and provided in conjunction with a selected note type, template, etc. Documents can be associated with a section navigator 1330, selectable by a user. Each document is associated with a status 1340 indicating a state of completion of that document 1330. A resulting note 1350 is then generated.

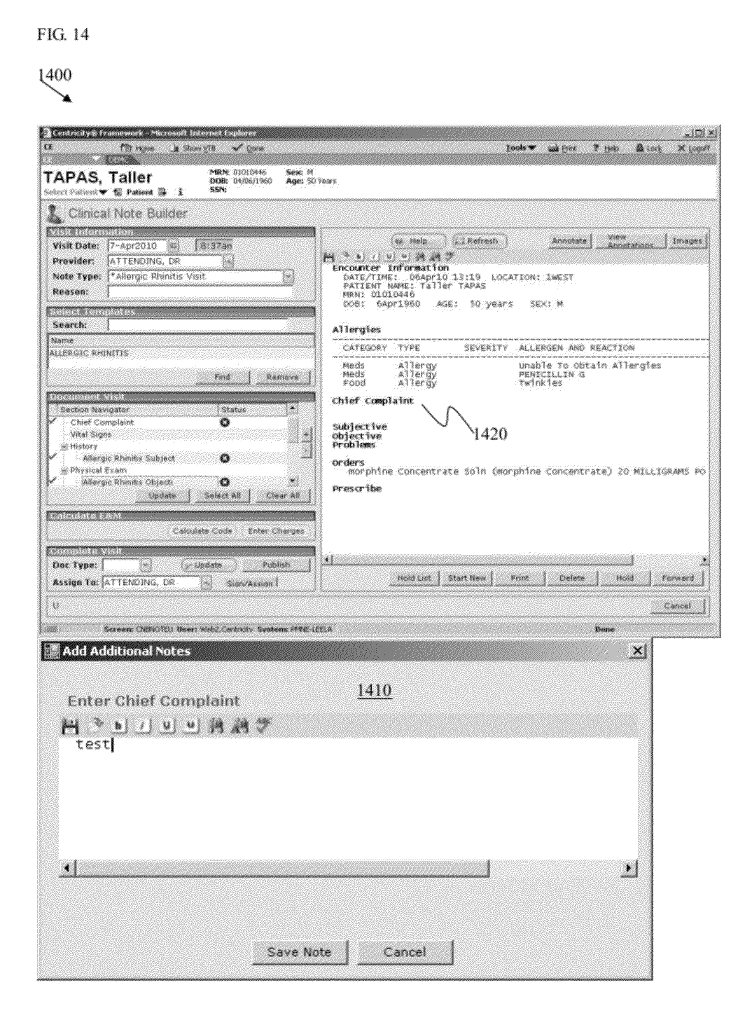

FIG. 14 illustrates an example of an additional note 1410 being added to a clinical note 1420 via a note builder 1400. As shown in the example of FIG. 14, a window or form 1410 for an additional note, such as entry of a chief complaint to supplement and/or complete information in a note 1420.

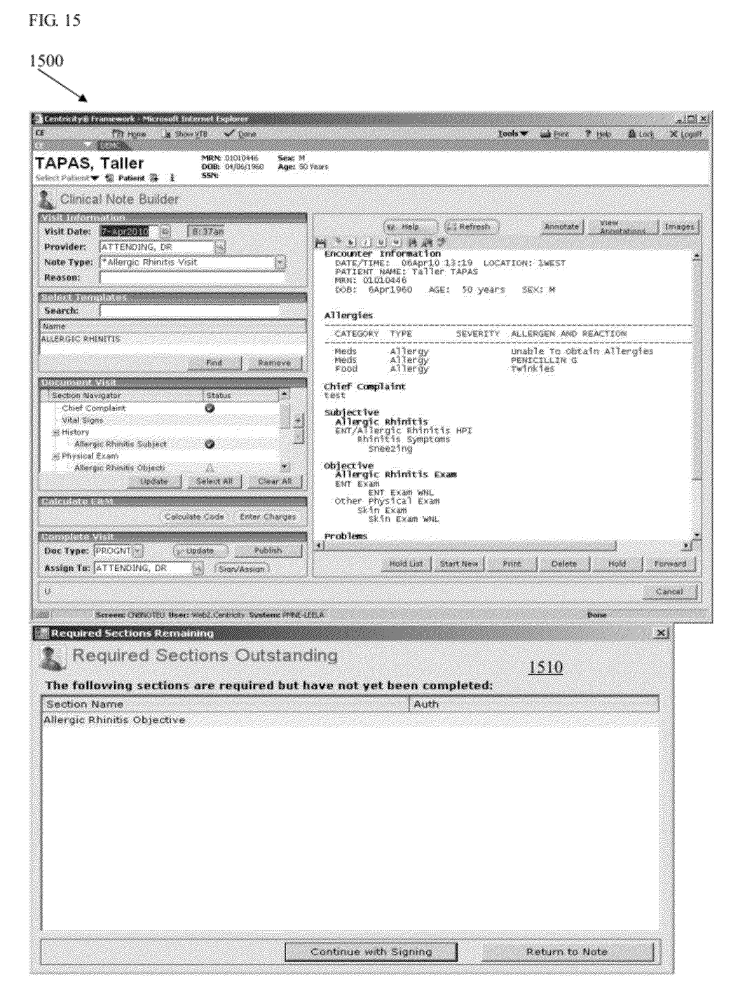

FIG. 15 illustrates an example note builder interface 1500 including an alert 1510 indicating that one or more sections are required but not yet completed. For example, if a required clinical note section is missing (e.g., an allergic Rhinitis objective), then the alert 1510 may be generated to trigger a user input and/or other response before continuing (e.g., continuing to sign and finalize the note).

Certain examples provide integrated patient discharge instructions with an electronic health record. Previously, users of an electronic health record were required to do a very fragmented workflow in creating an inpatient discharge record, including patient instructions. Certain examples provide integrated evidence-based patient discharged instructions with other critical information, such as medication reconciliation, follow-up orders, and other instructions. In addition, the instructions can be delivered in the primary language of the patient and family members, based on the licensed used by the hospital.

In certain examples, from a single screen, clinicians can create a discharge instruction for the patient, with clinical information automatically pulled into the instructions, as well as pre-selected instructions specific to the patient's primary language.

Certain examples provide access to a plurality of components of an electronic health record, including order entry (e.g., follow-up orders and referrals), medication reconciliation, medication prescribing and e-prescribing, electronic signature capture and storage, patient discharge instructions for diagnoses, procedures and forms (such as return to work, school, etc.), and ICD-9/ICD-10 coding. Certain examples update and manage evidence-based content.

In addition to clinical notes, patient discharge instructions can be generated. In certain examples, a Patient Discharge Instructions (PDI) module allows clinicians to gather information for a patient's discharge regarding the patient's diagnosis, follow up/referral orders, discharge medications, and pertinent clinical data (e.g., procedures, problems, and/or allergies). The clinical information is used to search for patient instruction topics and the discharge medications are used to search for drug monographs. The module also allows a user to make ad-hoc searches of patient instruction topics and of forms like work/school excuse for absence/tardiness, diabetes medication/diet/blood sugar chart, etc. Together, the clinical information, patient instruction topics, follow up/referral orders, discharge medications (along with a medication reconciliation report), drug monographs, and ad-hoc forms, form the discharge instructions document given to the patient. Additionally, patient signature can be captured (e.g., electronically or manually) to acknowledge receiving the discharge instructions document.

In certain examples, a patient discharge instructions (PDI) document can be initiated. A user can verify, add, or remove diagnoses to the PDI document. A user can verify, add, or remove patient instruction topics added by the application or the user to the PDI document for diagnoses. A user can verify, add, or remove follow up/referral orders to the PDI document. A user can verify, add, or remove discharge medication orders to the PDI document. A user can verify drug monographs added by the application to the PDI document for discharge medications. A user can verify a medication reconciliation report added by the application to the PDI document. A user can verify, add, or remove other clinical data (e.g., procedures, problems and/or allergies) to the PDI document. A user can verify patient instruction topics added by the application to the PDI document. A user can add or remove ad-hoc content forms. A user can capture the patient's signature electronically or manually, or acknowledge that a signature is not captured.

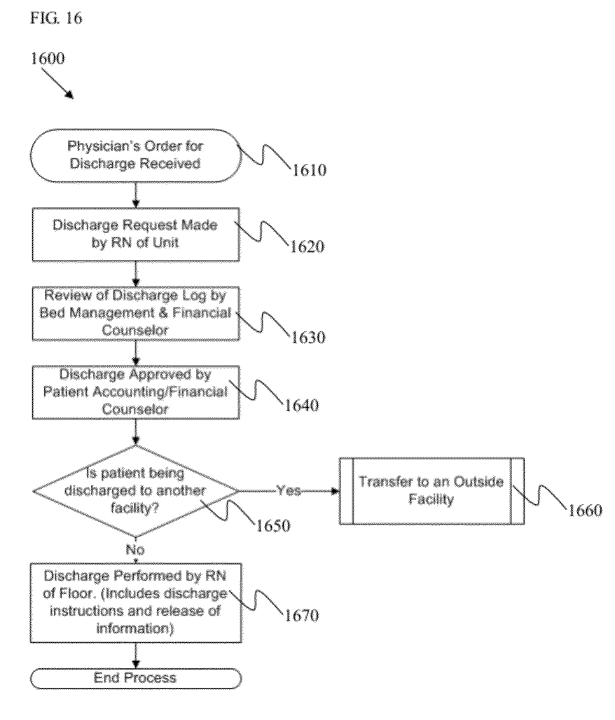

FIG. 16 illustrates a flow diagram for a method 1600 for completion of tasks to discharge a patient from a facility. At block 1610, a physician's order for discharge is received. At block 1620, a discharge request is made by a nurse of the unit. At block 1630, a Bed Management and Financial Counselor reviews the discharge log. At block 1640, the discharge is approved by Patient Accounting/Financial Counselor. At block 1650, it is determined if the patient is being transferred to another facility. If yes, at block 1660, a workflow continues below. If no, at block 1670, discharge is performed by the floor nurse. This includes discharge instructions and release of information, for example.

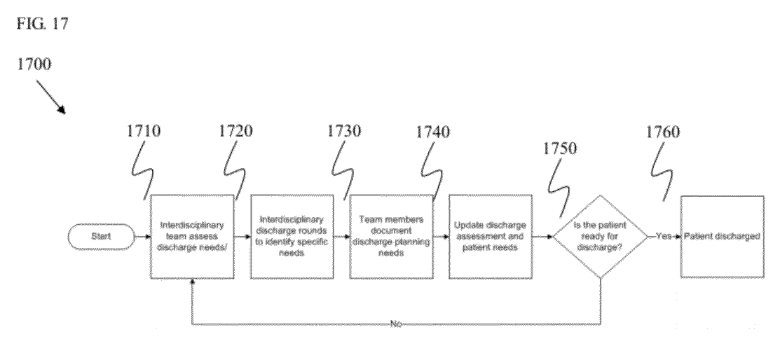

FIG. 17 illustrates a flow diagram for a method 1700 to determine a patient's discharge needs. At block 1710, an interdisciplinary team assesses the patient's discharge needs. At block 1720, specific needs are identified at Interdisciplinary Discharge Rounds. At block 1730, document discharge is planned. At block 1740, discharge assessment and patient needs are updated. At block 1750, it is determined if the patient is ready for discharge. If yes, then at block 1760, the patient is discharged. If no, the process repeats.

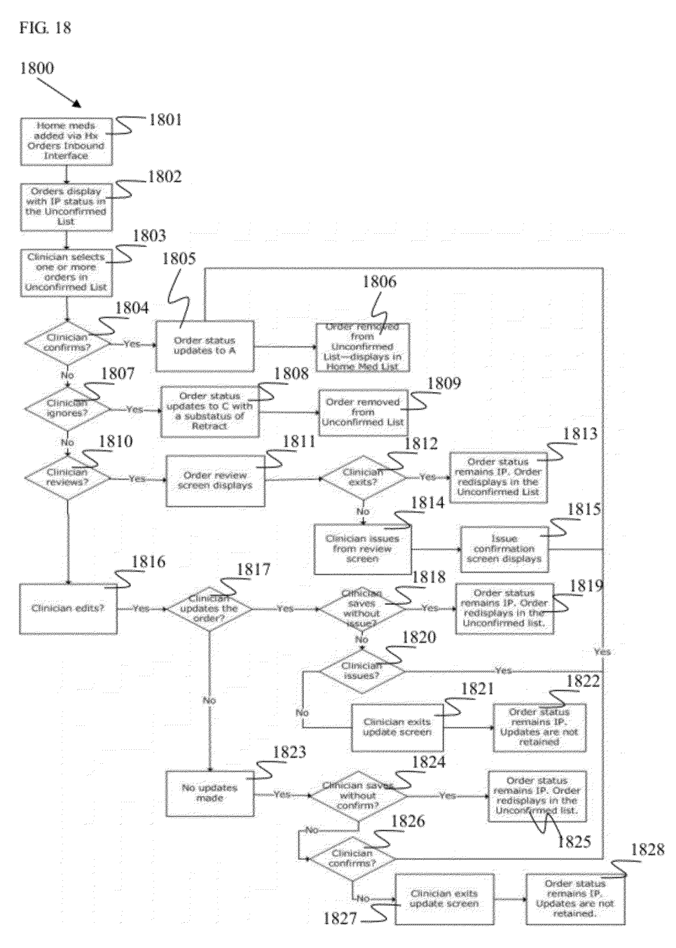

FIG. 18 illustrates a flow diagram for a home medication reconciliation workflow. The method or workflow 1800 is to reconcile a patient's list of medications received from another system. These are medications that the patient is taking, or was taking at home. A clinician reconciles these orders, confirming or rejecting them against a list of home medications that have already been recorded. For example, the patient arrives in the hospital setting. The clinician activates the patient and displays the patient's known home medications. A home medications interface screen displays medications received inbound from a document repository as Unconfirmed Historical Medications. These medications can display in a separate list on a home medications/records screen. The clinician reviews each unconfirmed medication with the patient. If the patient verifies he or she is currently taking the medication, the clinician confirms the medication. The medication status is updated to active, and the medication is removed from the Unconfirmed list and displays in the Confirmed Medication list. If the patient denies taking the medication, the clinician rejects the medication. The medication status/substatus is updated to C/Retract. The medication is filtered off from display on the Unconfirmed or Confirmed medication lists. The clinician reviews that the Active Meds on the Confirmed list are complete and accurate with the patient. If the patient is not taking any of the medications, the clinician discontinues them. If there are new medications the patient is taking, the clinician creates a new historical order to document the new medication. When all medications have been reconciled, the clinician indicates the patient's home medications have been reviewed.

At block 1801, home medications are added via an inbound orders interface. At block 1802, orders are displayed with a status of in process or in progress (IP), for example, in an unconfirmed list for clinician review. At block 1803, the clinician selects one or more orders in the unconfirmed list. At block 1804, the clinician can then confirm selected order(s). At block 1805, if the clinician confirms, the confirmed order status updates, and, at block 1806, the confirmed order is removed from the unconfirmed list. At block 1807, it is determined whether the clinician is ignoring the order. If yes, the order status is updated to “retract”, and, at block 1809, the order is removed from the unconfirmed list.

If the clinician is not ignoring the order, then at block 1810, the clinician is able to review the order. At block 1811, the order is provided to the clinician via an order review screen. At block 1812, the clinician can exit or continue. If the clinician exits, at block 1813, the order status remains IP. The order continues to be displayed in the unconfirmed list. At block 1814, the clinician can issue the order from the review screen, and, at block 1815, an issue confirmation screen is provided to the clinician user.

At block 1816, if the clinician exits, then at block 1817, the clinician can update the order. If so, at block 1818, the clinician is prompted to save without issuing the order. At block 1819, if the clinician saves without issuing the order, the order remains in process in the unconfirmed list. At block 1820, if the clinician decides not to save and not to issue, at block 1821, the clinician exits the update screen and, at block 1822, the order remains IP in the unconfirmed list.

If the clinician issues the order, then, at block 1826, the clinician can confirm. If so, the order issues. If not, then, at block 1827, the clinician exits the update screen and, at block 1828, the order status remains IP and updates are not retained. At block 1823, if no updates are to be made to the order, the clinician is also asked to confirm at block 1826.

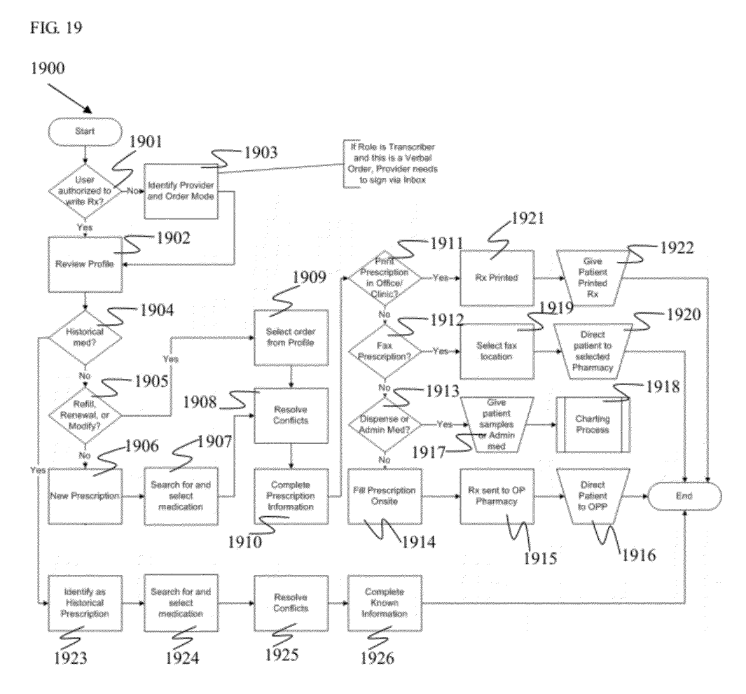

FIG. 19 illustrates a flow diagram for a method 1900 to process a prescription for an ambulatory patient. The method 1900 is to dispense medication, administer medication, or send the prescription to an on site or off site pharmacy, for example. At block 1901, it is determined if user is authorized is authorized to write a prescription (Rx). If yes, then the method proceeds to block 1902. If no, at block 1903, a provider and order mode are identified. If role is transcriber and this is a verbal order, the provider needs to sign via an input box, for example. At block 1902, a profile is reviewed. At block 1904, it is determined if this is a historical medication. If yes, the method continues at block 1923.

If no, at block 1905, it is determined if this is a refill, renewal, or modification. If yes, an order is selected from the profile, and the method continues at block 1909. If no, at block 1906, a new prescription is crated. At block 1907, medication is searched and selected. At block 1908, conflicts are resolved. At block 1910, prescription information is completed.

At block 1911, it is determined if the prescription should be printed. If yes, at block 1921, the prescription is printed and, at block 1922, given to the patient, and the method ends. If no, at block 1912, it is determined if the prescription should be faxed. If yes, at block 1919, a fax location is selected, and, at block 1920, the patient is directed to a selected pharmacy. The method then ends. If no, then, at block 1913, it is determined if the provider should dispense or administer the medication. If yes, at block 1917, the patient is given samples or the medication is administered, and, at block 1918, a charting process is executed. If no, then, at block 1914, the prescription is filled on site. At block 1915, the prescription is sent to an outpatient Pharmacy, and, at block 1916, the patient is directed to the outpatient pharmacy and the process ends.

At block 1923, the prescription is identified as a historical prescription. At block 1924, the medication is search and selected. At block 1925, conflicts are resolved. At block 1926, known information is completed, and the process ends.

Certain examples provide an ability to create a Discharge Instructions document via an application. The Discharge Instruction document can include several or all of the following sections: diagnosis, a reconciliation of current and discharge medications and prescriptions, follow up referrals and appointments, discharge instructions and additional notes, etc.

The application presents the user a screen with the sections of data containing patient diagnosis, current and discharge medications, potential provider referrals for follow up services, patient allergies, and problems. The application also provides options to enter or modify the information in those sections.

The application provides users with an ability to select from the suggested instructions, search for additional/alternate instructions (e.g., from Local Instructions Database) and/or type their own instructions if the suggested or searched ones are not appropriate.

The discharge instruction topics can be obtained from a third party repository such as ExitCare or other content vendor. The third party application facilitates an upload of information to a copy of their database containing the discharge instruction topics in a location accessible to the enterprise clinical system. The Discharge Instructions application provides a tool that uploads the third party content to a clinical database. The upload tool provides an ability to detect new versions of instruction topics that were used previously as templates for customized topics and notify users of the content change.

The Discharge Instructions application provides options for analysts to configure the application, as well as to maintain (add, modify, delete and display) the Local Instructions Database.

Upon request by the user to save the document and print it, the application creates a service to be linked to the document generated in order to facilitate retrieval of the document at a later time in case it needs to be printed again.

After printing the document, the application provides an ability to capture the patient's signature via an electronic device and attach it to the document.

Discharge Instructions: Clinicians are able to verify the accuracy of the information included in the Discharge Instructions document before the release of the document to the patient.

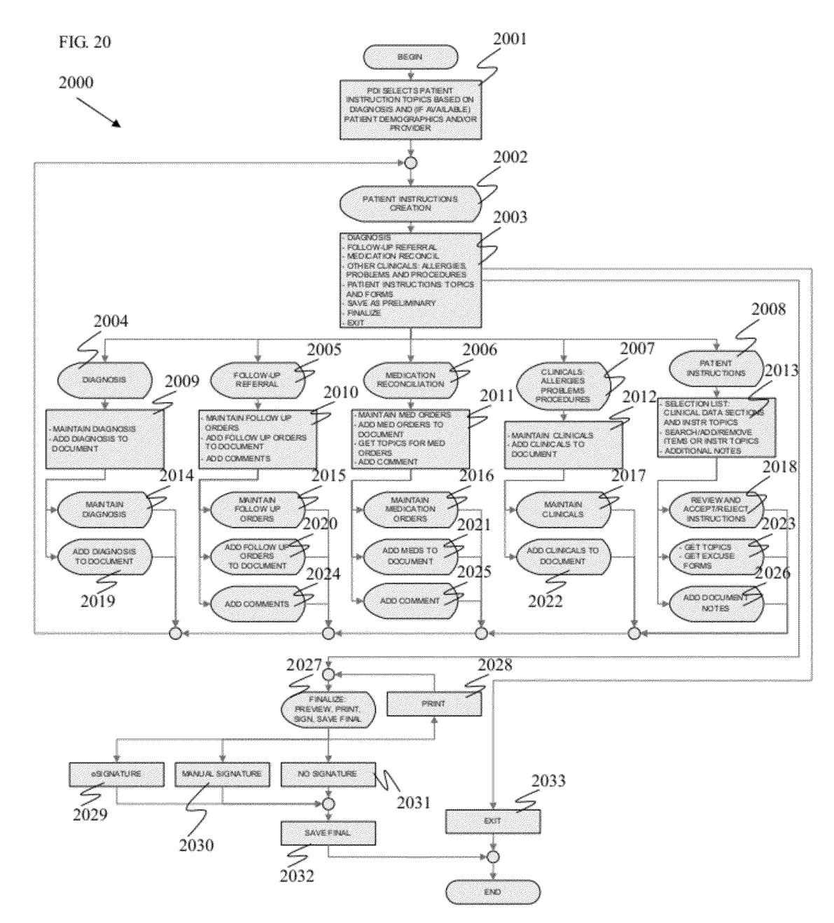

FIG. 20 illustrates an example PDI creation workflow 2000. At block 2001, patient discharge instruction topics are selected based one or more criterion including a diagnosis, patient demographics, and/or provider, etc. At block 2002, patient instructions are created based on the selected criterion(-ia) and retrieved information. At block 2003, instructions are generated to include information such as a diagnosis, follow-up referral, medication reconciliation, other clinical information (e.g., allergies, problems, procedures, etc.), patient instructions (e.g., topics, forms, etc.), etc. As discussed above, the form can be saved as preliminary for further review and/or edit and then finalized and saved.

At block 2004, for a diagnosis in the patient instructions, a user can, via an interface at block 2009, maintain a diagnosis (2014), add a diagnosis to the PDI document (2019), etc. At block 2005, for a follow-up referral, a user can, at block 2010, maintain follow-up orders (2015), add follow-up orders to the document (2020), add comments (2024), etc. At block 2006, for medication reconciliation, a user can, at block 2011, maintain medication orders (2016), add medication orders to the PDI document (2021), get topic(s) for one or more medication orders, add a comment (2025), etc. At block 2007, to add clinicals including allergies, problems and/or procedures, at block 2012, the user can choose to maintain clinicals (2017), add clinicals to the document (2022), etc. At block 2008, to provide patient instructions, at block 2013, the user can access, via a selection list at block 2018, review and accept/reject instructions including clinical data sections and instruction topics. The user can also search topics, get excuse forms, and add or remove items or instruction topics at block 2023. At block 2026, document notes can also be added.

After the instruction document has been constructed, at block 2027, the document is finalized. For example, the PDI document can be previewed, printed, signed, and saved as final. At blocks 2029-2031, the document can be electronically signed, manually signed, left unsigned, etc. The document can then be printed at block 2028. The signed/unsigned finalized document is saved at block 2032. The process 2000 exits at block 2033.

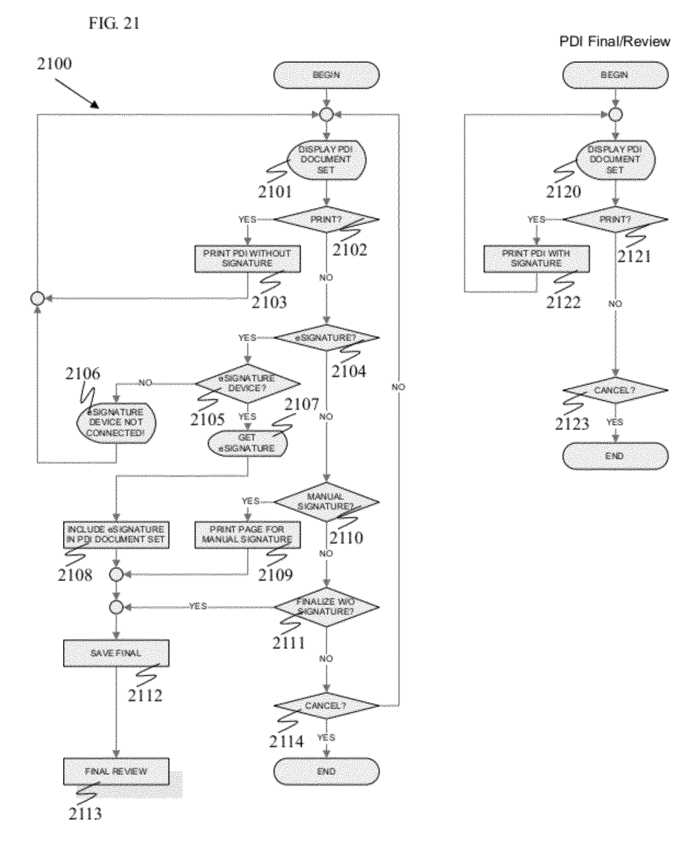

FIG. 21 illustrates a flow diagram for an example PDI finalization workflow 2100. At block 2101, a PDI document set is displayed (e.g., via a graphical user interface such as a clinical notes builder interface, etc.). At block 2102, the user can print all or part of the document set. If so, at block 2103, the PDI document set can be printed without signature. If not, then, at block 2104, the user and/or system is queried for an electronic signature. If the document is to be signed electronically, then at block 2105, an electronic signature device is detected. If a device is not detected, then at block 2106, the process 2100 may restart. If a signature device is detected, then, at block 2107, an signature is obtained. At block 2108, the electronic signature is included in the PDI document set. At block 2110, if a manual signature is to be obtained, then at block 2109, a page is printed for manual clinician signature. At block 2111, if no signature is obtained, the user is queried to verify that the PDI document set is to be finalized without signature. If not, then at block 2114, the user is asked whether to cancel and restart or end. At block 2112, the PDI document set is finalized and saved and, at block 2113, provided for final review.

At block 2120, the finalized PDI document set is displayed for final review. At block 2121, the user is given an option to print the document. If so, at block 2122, the PDI document set is printed with signature. If not, at block 2123, the user can cancel the final review.

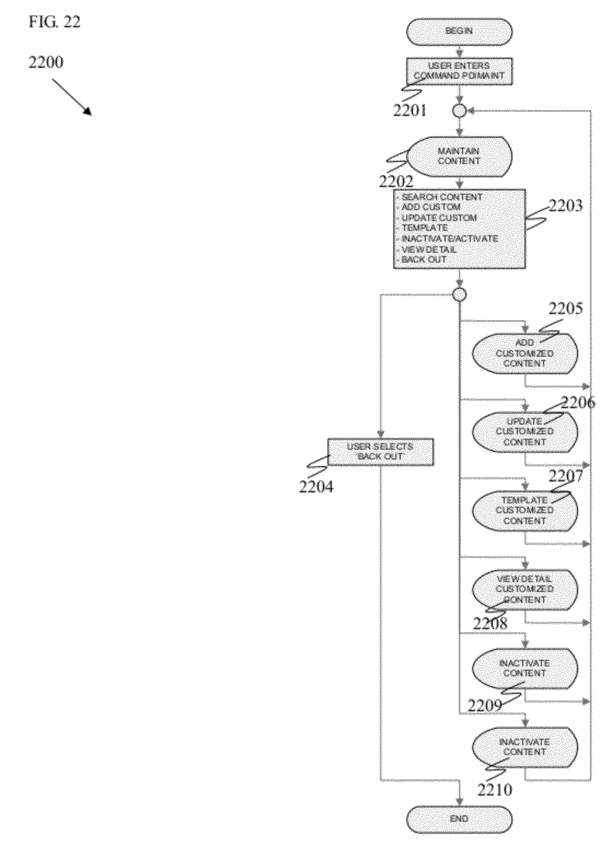

FIG. 22 depicts a flow diagram for an example PDI maintenance workflow 2200. At block 2201, a user enters a PDI maintenance command via an interface to initiate the workflow 2200. At block 2202, PDI content can be maintained. For example, at block 2203, a user can search content, add customized content (block 2205), update customized content (block 2206), provide a template for customized content (block 2207), view detail regarding customized content (2208), inactivate content (2209), activate content (2210), etc. At block 2204, a user can “back out” to end the maintenance.

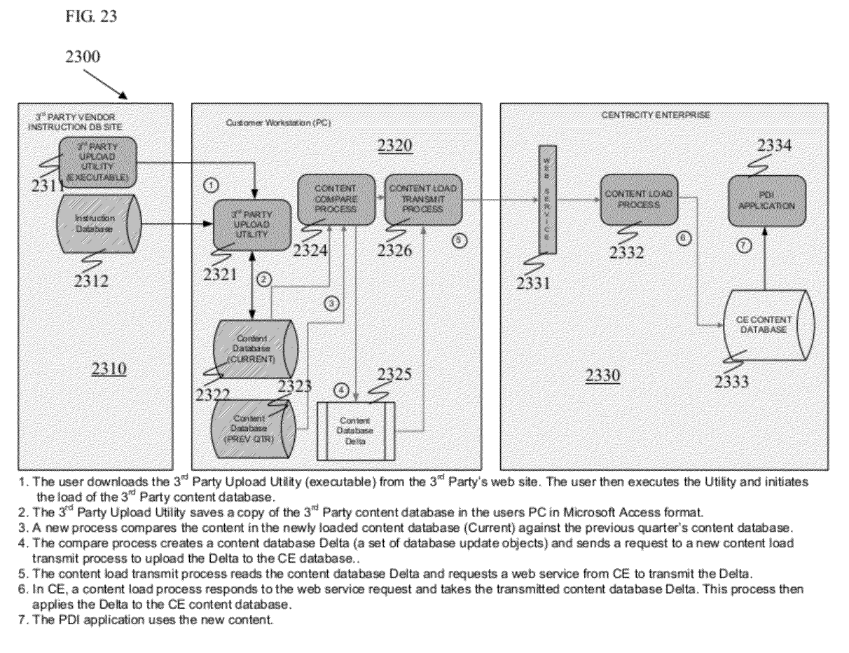

FIG. 23 illustrates a flow diagram for an example method 2300 for a content database load. As shown in the example of FIG. 23, a third party vendor site 2310 includes an upload utility 2311 and an instruction database 2312. At a customer computer 2320, a user downloads the third party upload utility and installs the utility 2321 on the computer 2320. The user then executes the utility 2321 and initiates a load of a content database 2322. The upload utility 2321 saves a copy of the content database 2322 at the computer 2320. A comparison process 2324 compares the content in the newly loaded content database 2322 with a previous content database (e.g., a previous quarter's content database). The compare process 2324 creates a database delta 2325 (e.g., a set of database update objects) and sends a request to a new content load transmit process 2326 to upload the delta 2325 to a clinical enterprise platform 2330. The content load transmit process 2326 reads the delta 2325 and requests a web service 2331 from the enterprise platform 2330 to transmit the delta 2325. A content load process 2332 responds to the web service 2331 and takes the transmitted content database delta 2325. The load process 2332 then applies the delta 2325 to an enterprise content database 2333. A PDI application 2334 can then use the updated content 2333.

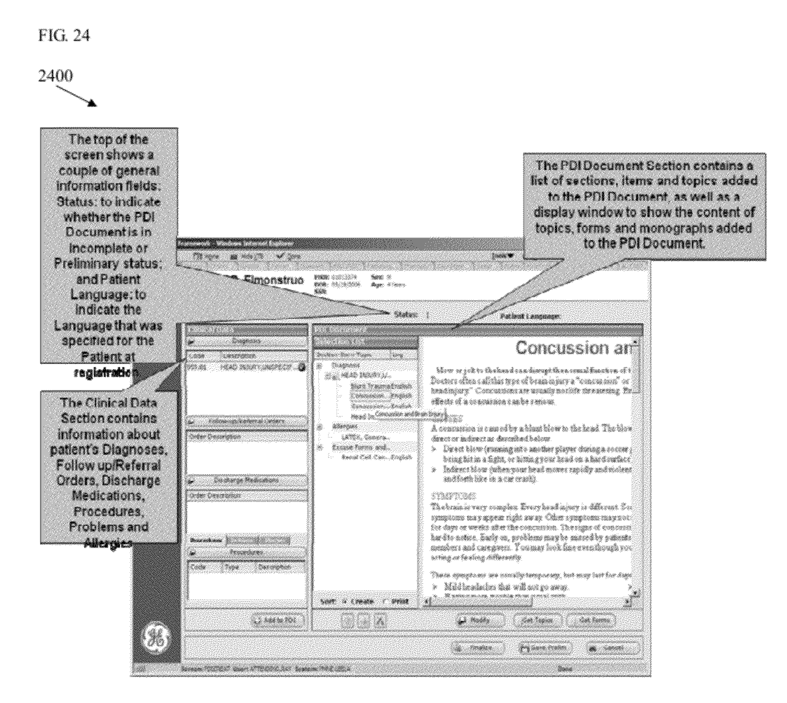

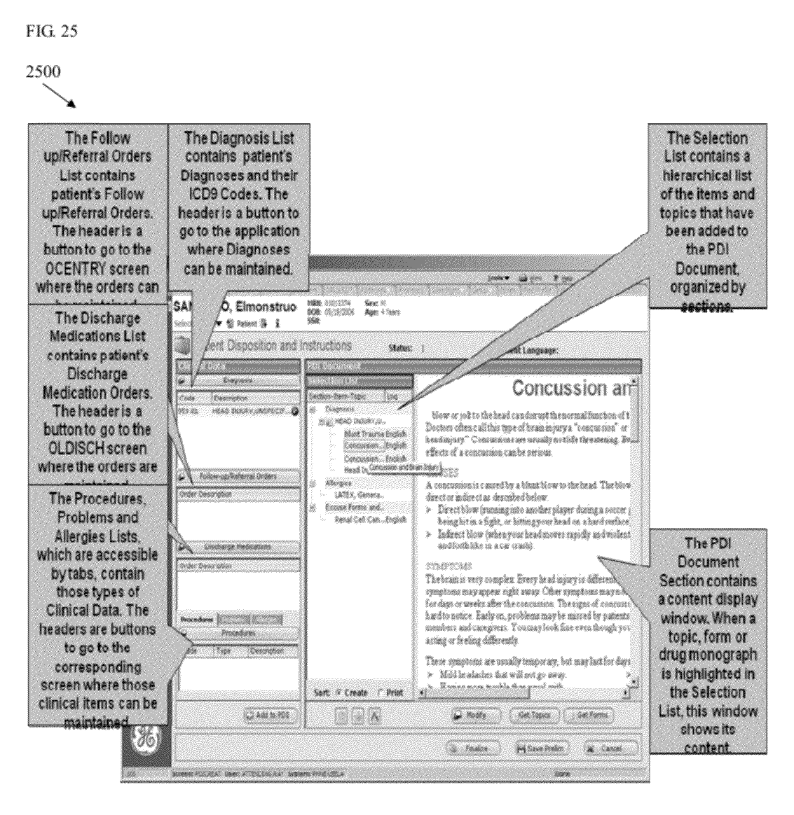

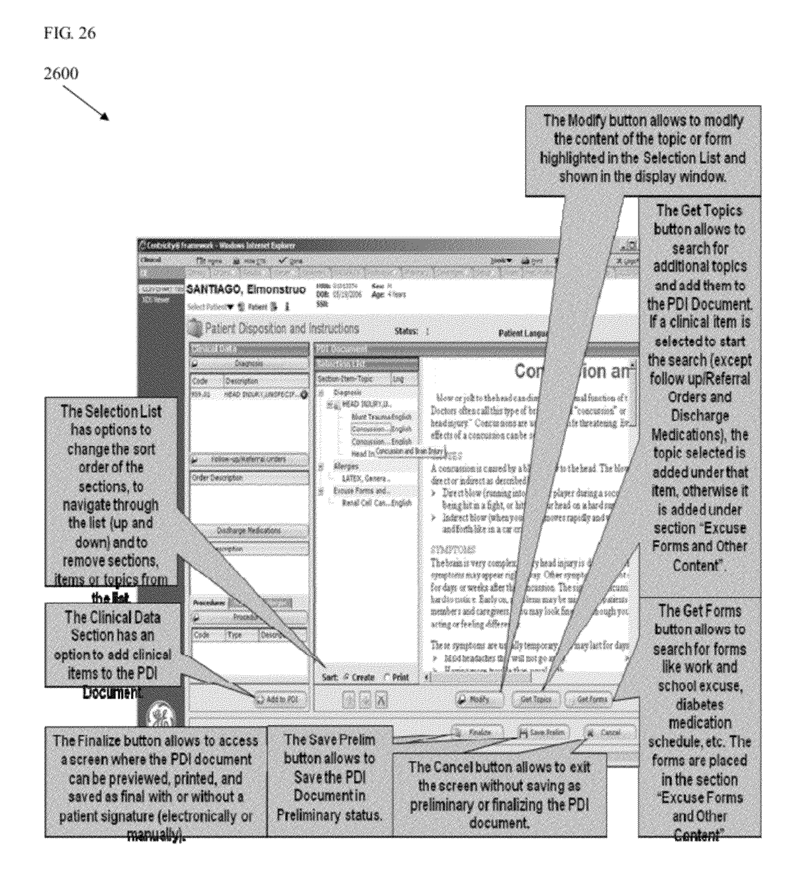

FIGS. 24-26 illustrate examples of PDI creation interfaces. As illustrated in the example figures, the user can specify and configure a variety of sections, items and topics. Lists can be specified, selected, etc., via the interface. PDIs can be saved as preliminary, modified, finalized, etc. Forms and other content can be retrieved for inclusion in a PDI. In certain examples, an interface allows users to modify topics or forms after they are added to the PDI Document. In certain examples, however, versions of the modified topics or forms cannot be saved as customized documents, and are only available within the service under which the PDI Document was created.

Certain examples provide an ability and interface to allow users to search for topics, whether they are related to a clinical item in the Selection List of the PDI creation screen or not. In the first case, the topic selected in this screen is placed under the clinical item that was selected in the Selection List to begin the search; in the second case, the topic selected is placed under the section “Excuse Forms and Other Content”. In certain examples, a user can search for forms, etc.

Thus, certain examples provide different statuses and different permissions that can be set for a PDI document. Different permissions can be set to work with different workflows (e.g., nurse can start and doctor can finish, etc.), for example. Certain examples automatically look for patient discharge instruction documentation. For example, a collection of documents is analyzed for diagnosis, procedures, allergies, etc. Documents can be retrieved based on the code of the diagnosis (e.g., ICD-9 codes), for example.

Certain examples analyze available database(s) to identify relevant documents. The clinician can review the recommended documentation and add and/or remove documents before providing PDI to the patient.

Certain examples provide clinical data associated with an episode of care that the patient is being discharged from. Lists of follow-up/referral orders and medication orders can be provided with the PDO. A diagnosis can be automatically provided so the clinician can tell the patient what to take care of when going home, for example.

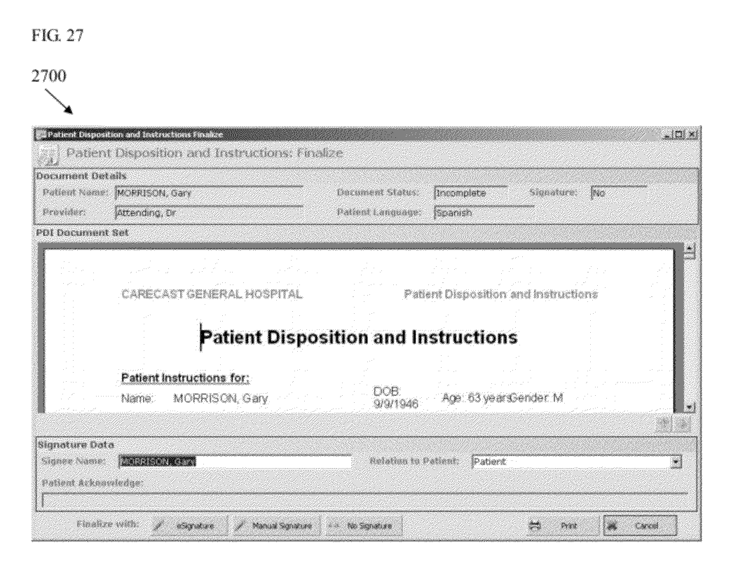

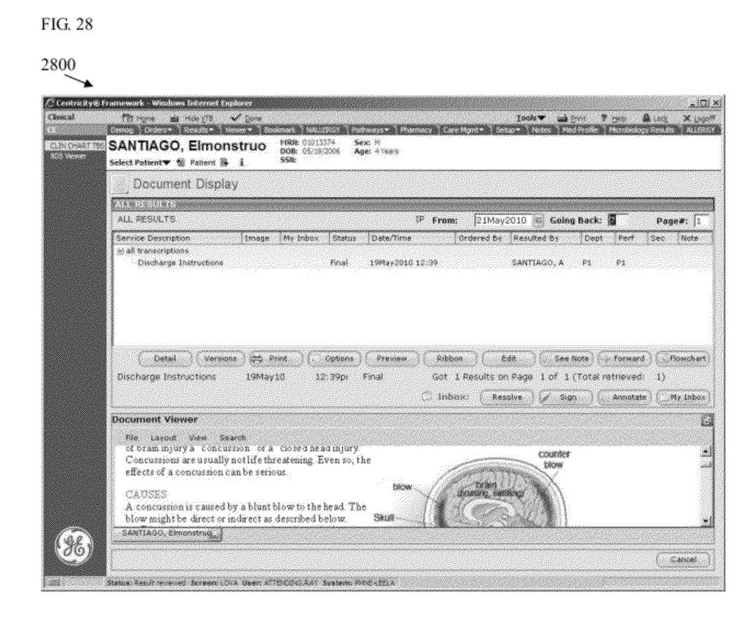

FIG. 27 illustrates an example interface to allow users to Preview, Print and Finalize the PDI Document with the following options for patient signature: 1) eSignature: allows users to collect the signature using an electronic input device; 2) Manual Signature: allows users to collect the signature using a print signature page; 3) No Signature: allows users to finalize the PDI Document without the signature, for example. A user can then review and print a finalized PDI document. As shown in the example of FIG. 28, a user can access a PDI document set once the document set is finalized. Upon selection of a document, a document display presents a preview of the document, for example.

Certain examples provide Registry and quality measure management tools embedded within an electronic health record. Certain examples provide an ability to set specific criteria for identifying patients that may qualify for national, state and institution-based quality measures and protocols. Based on the criteria established, such as an ICD-9 code range, finding, diagnosis, etc., a patient can be automatically or conditionally placed on a registry, initiating specific actions and notifications for the care of the patient.

Hospitals and ambulatory care settings have increasing number of measures and reporting requirements, rules, and/or guidelines for patient populations. By integrating tools that improve the identification of patients that may qualify for specific protocols and management of care.

The Registries module helps clinicians to be aware of and compliant with their organization's evidence-based guidelines to achieve the best outcomes for their patients.

Health care organizations can determine whether a set of standards apply to a patient based on the capture of relevant health history, demographic information, and diagnoses. Health care organizations can deliver care in compliance with the standards. Health care organizations can identify the patients that fall within a population for formal reporting purposes and facilitate the data collection process for those patients.

Certain examples provide one or more interfaces to facilitate review of patient registries, add patients to a registry, remove patients from a registry, activate or inactivate registry members, reject candidates to a registry, confirm candidates to a registry, review current registry information for a specific patient, review patient registry membership history, review patient detail and chart detail from registries, and/or set up registry user preferences, for example.

In certain examples, there are two types of patient registries: longitudinal and episodic. Longitudinal registries are used for identifying and tracking patient populations on a long-term basis, for example, a registry of diabetes patients. When a patient is discharged at the end of a visit, their status in the registry stays active since their problem is chronic and long term. Episodic registries are used for identifying and tracking inpatient patient populations; a patient is a member of such a registry for the duration of their inpatient stay. An example of an episode of care registry is for stroke or acute myocardial infarction patients. When the patient is discharged, the patient's status in the registry is changed to Inactive.

Certain examples provide advanced registry management tools, batch management and reporting.

The following describes an example workflow for using a longitudinal registry:

1. A patient's provider at a clinic adds a specific problem to the patient's problem list. The problem triggers clinic-defined criteria for adding the patient to a specific registry for monitored populations (for example, the patient's problem is diabetes).

2. The patient is added to the registry.

3. Providers deliver care to the patient during a clinic visit.

4. The patient is discharged at the end of their visit. Their status in the registry remains active since they are on the longitudinal registry for a long term, chronic condition.

The following describes an example workflow for using an episodic registry:

1. The admitting clerk registers a patient in the system and enters admission data that triggers hospital-defined criteria for adding the patient to a specific registry for a monitored population. For example, the patient may have an admitting diagnosis that is a particular ICD9 code.

2. The system adds the patient to the registry as a candidate in pending status. Alternately, the system can be set up to add the patient directly to the registry if appropriate.

3. The system generates an Inbox notification to the patient's provider that tells them the patient has been added as a candidate member of a specific registry.

4. The provider receives the notification in their Inbox.

5. The provider assesses the patient and confirms the patient as a member of the registry with an active status (or rejects the patient as a member of the registry with a rejected status).

6. The system generates care steps associated with members of the registry (for example, a specified order set for stroke patients).

7. The provider delivers ongoing care to the patient throughout the patient's stay in the hospital.

8. The unit clerk discharges the patient in the system.

9. The system updates the patient's status in the registry to inactive.

Working with registries can be approached a variety of ways. With a registry-centered workflow, a user is working with a specific registry and the members of that registry. The user can review a list of patients in a specific registry, for example, all the patients in a Diabetic Registry. A user might select this workflow if he/she is working with a specific registry and want to perform maintenance tasks for the registry. The user does not need to activate a patient to use this command.

A registry-centered workflow can be used if a facility has set up a specific command to access a registry; for example, a specific command may be used to access a diabetic registry.

For the specific registry, a user can add a patient as a member, confirm or reject candidate patients, activate or inactivate patient members in the registry, undo rejections or patients added as members in error, review patient detail or patient chart detail, or review patient memberships in registries or patient registry history, for example.

In a patient-centered workflow, a user is working with a specific active patient and dealing with a list of the registries the patient is a member of. A user can use a command to review a list of registries that a specific patient belongs go. A user might use this workflow if he/she is working with a specific patient and want to see what registries they are members of A user needs to activate a patient to use this command.

For that specific patient, a user can confirm or reject the patient as a member of any of the registries, activate or inactivate the patient from any of the registries, undo rejections of the patient or undo additions to a registry in error, review the patient's detail or the patient's chart, or review a specific registry and its patient members or review the patient's registry history.

An inbox-centered workflow begins when a user opens a notification in his/her Inbox. A user can resolve Inbox notifications sent to him/her regarding patient candidacy or membership in a specific registry.

From the Select a Patient screen, which appears when a user selects a registry-related notification to resolve, the user can resolve the notification without taking further action, resolve the notification and review a specific registry, resolve the notification and review the patient's registry memberships, review a specific registry without resolving the notification, or review the patient's registry memberships without resolving the notification.

Once the user either selects to review a specific registry or review patient memberships, the user can follow the registry-centered work flow or the patient-centered workflow, respectively.

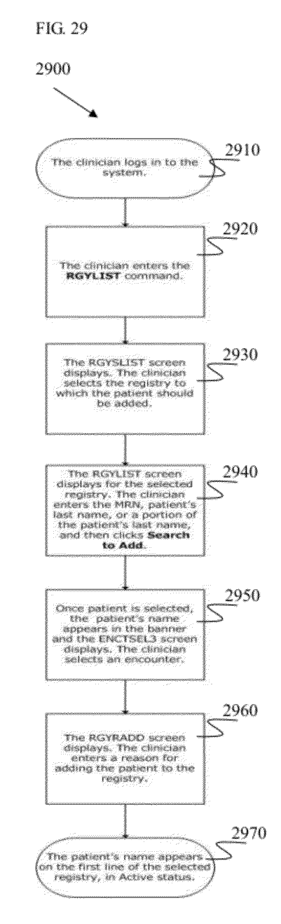

FIG. 29 provides a method 2900 for adding patients to a registry. At block 2910, a clinician wants to add a patient to a registry. At block 2920, the clinician logs on to the system. At block 2930, the clinician uses one of the following to access a Patient Registry List) screen. If the clinician has a reference that calls a specific Registry List screen, the clinician enters that command. The registry list screen for that registry displays. If the clinician does not have a reference that calls a specific Registry List screen, the clinician enters a registry list command. The List of Registries screen displays. The clinician selects the registry to which they want to add the patient. At block 2940, from the specific registry list screen, the clinician enters the patient's identification or reference number, if available, or enters the patient's last name in the Add Patient section, and then clicks Search to Add. If the reference matches a patient, the patient is activated in the patient banner and an Encounter Selection screen displays. If the last name (or a portion of the patient's last name) is entered, the Patient Activation Alert or Patient Name Lookup screen displays. This screen allows the clinician to select that patient by name. Once a patient is selected, the patient is activated in the patient banner and the Encounter Selection screen appears. At block 2950, from the Encounter Selection screen, the clinician selects the appropriate encounter, and then clicks Select. At block 2960, a registry add or change screen displays. This screen can be used to add this patient or change this patient's current status in the registry, for example. The clinician enters a reason for adding the patient to the registry and clicks Save. At block 2970, the patient is added to the top of the registry list in Active status.

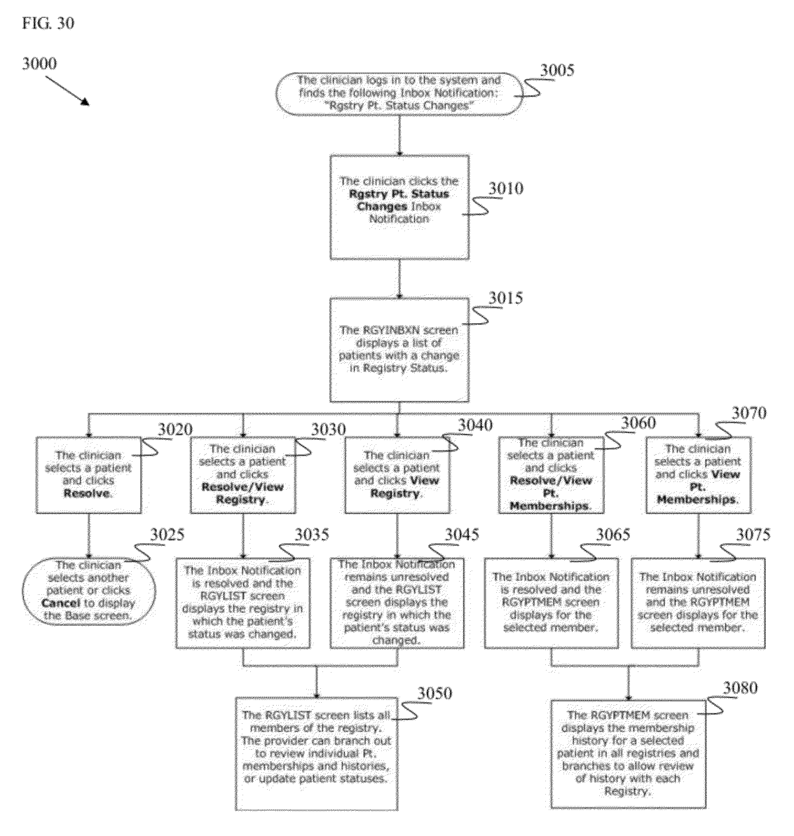

FIG. 30 provides a flow diagram for a method 3000 to notify of a change in patient status. To notify a patient's attending provider, primary care provider, or another user when the patient's status in a registry changes. When a change occurs, the clinician receives a notification in their Inbox, which states, for example, “Rgstry Pt. Status Changes.” This notification is for informational purposes only. The action that the clinician takes is to resolve the notification. At block 3005, the clinician receives a notification in Inbox that a patient's (or patients') registry status has changed. At block 3010, the clinician clicks a registry patient status changes notification. At block 3015, a select a patient screen displays, listing the registry members with status changes. The clinician may then choose one or more of the following options.

At block 3020, the clinician clicks Resolve to remove the notification from the user's Inbox. The user may then, at block 3025, select another patient and/or select a cancel option to display a base screen, for example.

At block 3030, the clinician clicks Resolve/View Registry to, at block 3035, remove the notification from Inbox and display a Patient Registry List screen for the specific registry in which the patient's status changed. The clinician can also, at block 3040, select a patient and to View Registry. At block 3045, clicking on or otherwise selecting View Registry leaves the notification in the clinician's Inbox and displays the Patient Registry List screen for the specific registry in which the patient's status changed. From this screen, the clinician can view all patients on the registry, change statuses in the registry, and view individual patient memberships and history. At block 3050, from a Patient Registry List screen, the provider can view all patients on the registry, change patient statuses in the registry, view individual patient registry memberships and history, etc.

At block 3060, the clinician can select Resolve/View Patient Memberships. At block 3065, this selection removes and/or otherwise resolves the notification from the Inbox and displays the Patient Registry Membership Listing screen for the selected patient. From this screen, at block 3080, the clinician can view individual registry memberships and history.

At block 3070, the clinician can click on or otherwise select View Patient Memberships. At block 3075, the notification is left in the user's Inbox and a Patient Registry Membership Listing screen is displayed for the selected patient. From this screen, at block 3080, the clinician can view the individual registry memberships and history and make changes to the patient's status.

Inpatient Quality Measure criteria are determined yearly and published in the Federal Register with the Inpatient Prospective Payment System regulations. Outpatient Quality Measure criteria are determined yearly and published in the Federal Register with the Outpatient Prospective Payment System regulations. Physician Office Quality Measure (PQRI) criteria are determined yearly and published in the Federal Register with the Physician Fee Schedule regulations.

For Inpatient and Outpatient Hospital Reporting is currently voluntary, however payment penalties exist for hospitals who do not participate For Physicians, reporting is also currently voluntary but payment incentives exist for those who participate. An example in-patient measure includes:

1. Aspirin at Arrival

2. Aspirin at Discharge

3. Angiotensin Converting Enzyme (ACE) Inhibitor or Angiotensin receptor Blocker (ARB) for Left Ventricular Systolic Dysfunction (LVSD)

4. Adult Smoking Cessation Advice/Counseling

5. Beta Blocker Prescribed at Discharge

6. Beta Blocker on Arrival

7. Thrombolytic Agent Received Within 30 Minutes of Hospital Arrival

8. Percutaneous Coronary Intervention (PCI) Received Within 90 Minutes of Hospital Arrival.

Registries, such as tumor registries, are maintained by hospitals. To create registries information is abstracted from records after the care is provided, too late to have any impact on the care process. Certain examples provide registry functions to assist in concurrently identifying patients who have a high likelihood of meeting an “end result” criteria that would place them on a Registry. These patients includes those patients whose care provided is measured against the standard and ultimately be reported on. Certain examples help to identify these patients in “real” time to help ensure that they would be provided care in accordance with the accepted standards. Statistics can be gathered after discharge for reporting, for example.

An example Registry module allows users to create “Registries” that can combine system and manual processes to identify and monitor patient populations whose conditions lend themselves to the care standards that have been adopted. Certain examples help identify a patient population before care is provided to help ensure that the care provided meets standards. Additionally, if there is a justifiable reason for it not meeting that standard, care providers can be alerted to clearly document why.

In certain examples, users can create Registries that allow patients to be manually added to a Registry and manually change statuses. Users can create Registries that “listen” for specific system events and, depending on the Event, will trigger the system to take a specific action. Users can create Registries that combine both of the above. Registries can be Episodic or Longitudinal. Episodic Registries are Registries in which the criteria for membership would be expected to exist for a relatively short interval, e.g., the duration of an inpatient hospital stay. Examples include AMI, Pneumonia, Stroke. Longitudinal Registries are Registries in which the criteria for membership would be expected to exist for the long term. Examples include Diabetic patients, Hypertensive patients, etc.

For example, once a user has created a Registry and linked a system event such as PRB.ADD.PROBLEM to a System Action, such as Add Candidate, additional evaluation criteria are added to specify exactly what problem(s) need to be added to the patient's problem list in order to place the patient on the Registry. In addition to PROBLEMS there are other possible types of evaluation criteria: Admitting diagnosis—which is linked to the System Event—ADT.ADMIT; Findings—which are linked to the System Events such as SERV.UPD.FINALASSESS; Blaze Rules can be set up to look for other specific criteria that will automatically add a patient to a Registry.

Once a “Rule” has been established (e.g., Rules include Events, Actions and Criteria), additional Registry Maintenance can be done to automatically trigger specific tasks such as: Notify the attending or primary care provider when a patient has been added to a Registry; Trigger an orderset, an Interdisciplinary Care Pathway or an EO orderset; Add a problem to the Patient's Problem List; Trigger an Expert Rule, etc.

For example, an Episodic Registry is created for Inpatients being treated for Acute Myocardial Infarction. The system event of ADT.ADMIT is linked to a System Action that will add the patient to the AMI Registry as a candidate when the patient's admitting diagnosis code is within the ranges identified in the Specifications manual for National Hospital Inpatient Quality Measures. When the above occurs, an inbox notification task is triggered to the Attending Physician informing him/her that his patient is a Registry candidate. After the attending physician confirms the patient as a member of the AMI Registry trigger an EO order set and add the problem of Acute Myocardial Infarction to the patient's problem list. The EO order set can be expressly tailored to include all of the measures included in the Specifications manual for National Hospital Inpatient Quality Measures. The system event of ADT.DISCH is linked to a System action that will inactivate the patient on the AMI Registry when they are discharged from the hospital, for example.

Registries may be accessed in several ways. For example, registries can be accessed by selecting the Registry from a listing of all Registries and/or by using patient specific commands to access a particular patient's registry membership and history details.

Using registries a healthcare organization is able to establish guidelines for their providers in the form of specific medications, assessments, counseling/advice, and discharge instructions for patients with evidence of a certain condition. Providers are able to monitor the patients with evidence of a certain condition and key data points associated with that population of patients. Abstractors are able to extract the list of patients with evidence of a certain condition along with key data points used for reporting on that population of patients. Qualification of a patient for specific registries can be done automatically, or pending clinician acceptance to a registry. Key clinical conditions, measures, and protocols can be managed via the registry application.

A registry provides a list of patients with similar or same diagnosis (e.g., tumor registry of patients with cancer). Certain examples provide registries with quality measures so that a user can use the registry module to identify patients who will be reported on in the quality measurement criteria.

Certain examples provide “mini-registries.” Certain examples provide a way for hospital organizations to create lists of patients with something in common to provide consistent care for patients (e.g., all patients with evidence of heart attack get treated according to certain guidelines). Certain examples check against criteria and then trigger rules and plan to treat the patient(s). Hospitals can define criteria, rules to be applied, and timing (a point in a process or care) at which the rules will be applied.

In certain examples, a registry can be selected, and events can be created (e.g., when patient admitted, problem added to flowsheet, etc.). For example, an ADT event (patient admission) is taken, and, when a patient admitted, the system action adds the patient as a candidate and notifies a care provider. An attending provider, primary care provider, patient, etc., can be notified that the patient is a candidate and help ensure it is appropriate and the patient should be added. A registry can be set up for automatic addition based on history, rules, etc. Once patients are on a list, there is now a common handle to pull them by. An inbox alert for a researcher/provider, etc., can be triggered, for example.

While an example manner of implementing systems and methods have been illustrated in the figures, one or more of the elements, processes and/or devices illustrated in the figures may be combined, divided, re-arranged, omitted, eliminated and/or implemented in any other way. Further, one or more components and/or systems may be implemented by hardware, software, firmware and/or any combination of hardware, software and/or firmware. Thus, for example, any of the example components and/or systems may be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the example components and/or systems are hereby expressly defined to include a tangible medium such as a memory, DVD, Blu-ray, CD, etc., storing the software and/or firmware. Further still, any of the example systems may include one or more elements, processes and/or devices in addition to, or instead of, those illustrated in the figures, and/or may include more than one of any or all of the illustrated elements, processes and devices.

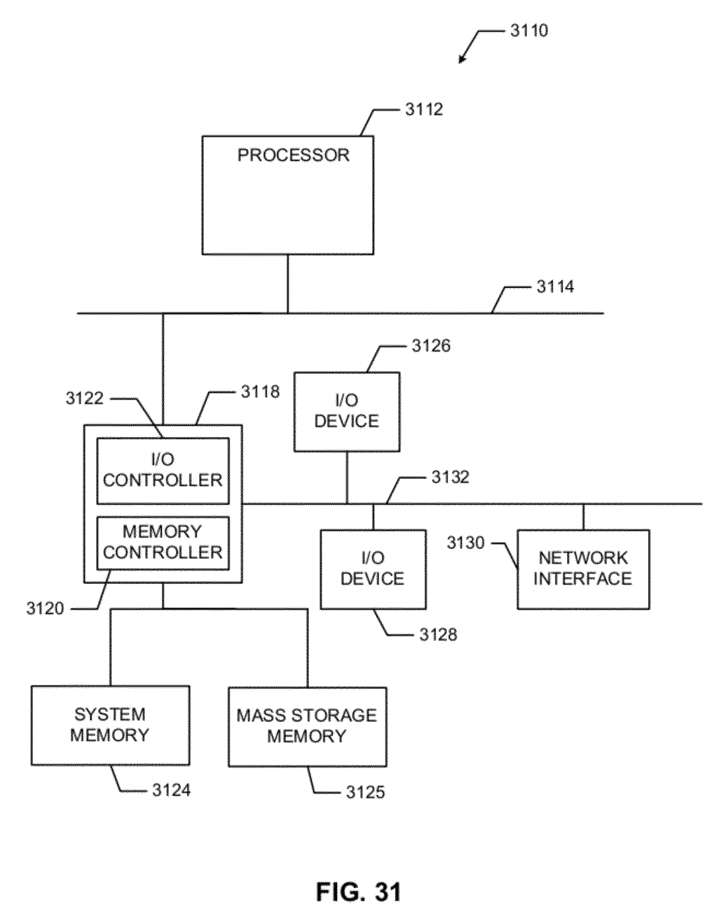

Flow diagrams and/or data flow depicted in and/or associated with the figures are representative of machine readable instructions that can be executed to implement example processes and/or systems described herein. The example processes may be performed using a processor, a controller and/or any other suitable processing device. For example, the example processes may be implemented in coded instructions stored on a tangible medium such as a flash memory, a read-only memory (ROM) and/or random-access memory (RAM) associated with a processor (e.g., the example processor 3112 discussed below in connection with FIG. 31). Alternatively, some or all of the example processes may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes may be implemented manually or as any combination(s) of any of the foregoing techniques, for example, any combination of firmware, software, discrete logic and/or hardware. Further, although the example processes are described with reference to the figures, other methods of implementing the processes of may be employed. For example, an order of execution may be changed, and/or some of the elements described may be changed, eliminated, sub-divided, or combined. Additionally, any or all of the example processes of may be performed sequentially and/or in parallel by, for example, separate processing threads, processors, devices, discrete logic, circuits, etc.

FIG. 31 is a block diagram of an example processor system 3110 that may be used to implement the systems, apparatus and methods described herein. As shown in FIG. 31, the processor system 3110 includes a processor 3112 that is coupled to an interconnection bus 3114. The processor 3112 may be any suitable processor, processing unit or microprocessor. Although not shown in FIG. 31, the system 3110 may be a multi-processor system and, thus, may include one or more additional processors that are identical or similar to the processor 3112 and that are communicatively coupled to the interconnection bus 3114.

The processor 3112 of FIG. 31 is coupled to a chipset 3118, which includes a memory controller 3120 and an input/output (I/O) controller 3122. As is well known, a chipset typically provides I/O and memory management functions as well as a plurality of general purpose and/or special purpose registers, timers, etc. that are accessible or used by one or more processors coupled to the chipset 3118. The memory controller 3120 performs functions that enable the processor 3112 (or processors if there are multiple processors) to access a system memory 3124 and a mass storage memory 3125.

The system memory 3124 may include any desired type of volatile and/or non-volatile memory such as, for example, static random access memory (SRAM), dynamic random access memory (DRAM), flash memory, read-only memory (ROM), etc. The mass storage memory 3125 may include any desired type of mass storage device including hard disk drives, optical drives, tape storage devices, etc.

The I/O controller 3122 performs functions that enable the processor 3112 to communicate with peripheral input/output (I/O) devices 3126 and 3128 and a network interface 3130 via an I/O bus 3132. The I/O devices 3126 and 3128 may be any desired type of I/O device such as, for example, a keyboard, a video display or monitor, a mouse, etc. The network interface 3130 may be, for example, an Ethernet device, an asynchronous transfer mode (ATM) device, an 802.11 device, a DSL modem, a cable modem, a cellular modem, etc. that enables the processor system 3110 to communicate with another processor system.

While the memory controller 3120 and the I/O controller 3122 are depicted in FIG. 31 as separate blocks within the chipset 3118, the functions performed by these blocks may be integrated within a single semiconductor circuit or may be implemented using two or more separate integrated circuits.

Certain examples contemplate methods, systems, apparatus, and/or computer program products on any machine-readable media to implement functionality described above. Certain examples may be implemented using an existing computer processor, or by a special purpose computer processor incorporated for this or another purpose or by a hardwired and/or firmware system, for example.

Certain examples include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Examples may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Examples may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Although certain methods, systems, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

1. A method comprising:
facilitating review and edit of a selected clinician document via a graphical user interface;
automatically reviewing, using a processor, and providing an indication of required information that has not been completed in the selected document;
facilitating user completion of uncompleted required information via the user interface;
saving the selected clinician document for later review, the selected clinician document associated with a completion status; and
finalizing the selected clinician document for output upon user approval via the user interface.

2. The method of claim 1, further comprising applying a template to the selected note.

3. The method of claim 1, wherein the selected clinician document comprises patient discharge instructions.

4. The method of claim 1, further comprising publishing the selected clinician document for review.

5. The method of claim 1, wherein finalizing comprises receipt of user approval and signature.

6. The method of claim 1, further comprising providing a list of saved documents for review and an indication of a status associated with each document.

7. The method of claim 6, wherein the status is indicated using a graphical icon.

8. The method of claim 1, wherein saving further comprises saving an indication of where in the document the user stopped completing an input or selection of information.

9. The method of claim 1, further comprising triggering a suggestion to add a patient to a registry based on content in the selected clinician document.

10. A tangible computer-readable storage medium including instructions for execution by a processor, the instructions when executed implementing a method to facilitate clinician documentation, the method comprising:
facilitating review and edit of a selected clinician document via a graphical user interface;
automatically reviewing and providing an indication of required information that has not been completed in the selected document;
facilitating user completion of uncompleted required information via the user interface;
saving the selected clinician document for later review, the selected clinician document associated with a completion status; and
finalizing the selected clinician document for output upon user approval via the user interface.

11. The computer-readable storage medium of claim 10, wherein the method further comprises applying a template to the selected note.

12. The computer-readable storage medium of claim 10, wherein the selected clinician document comprises patient discharge instructions.

13. The computer-readable storage medium of claim 10, wherein the method further comprises publishing the selected clinician document for review.

14. The computer-readable storage medium of claim 10, wherein finalizing comprises receipt of user approval and signature.

15. The computer-readable storage medium of claim 10, wherein the method further comprises providing a list of saved documents for review and an indication of a status associated with each document.

16. The computer-readable storage medium of claim 15, wherein the status is indicated using a graphical icon.

17. The computer-readable storage medium of claim 10, wherein saving further comprises saving an indication of where in the document the user stopped completing an input or selection of information.

18. The computer-readable storage medium of claim 10, wherein the method further comprises triggering a suggestion to add a patient to a registry based on content in the selected clinician document.

19. A system comprising a processor and a memory, the memory storing instructions to enable the processor to implement a user interface arranged to:
facilitate review and edit of a selected clinician document via a graphical user interface;
automatically review, using the processor, and provide an indication of required information that has not been completed in the selected document;
facilitate user completion of uncompleted required information via the user interface;
save the selected clinician document for later review, the selected clinician document associated with a completion status; and
finalize the selected clinician document for output upon user approval via the user interface.

20. The system of claim 19, wherein the processor is arranged to provide a list of saved documents for review and an indication of a status associated with each document.
